(19) United States
(12) Patent Application Publication
(10) Pub. No.: US 2010/0109983 A1
(43) Pub. Date: May 6, 2010

(54) PLASMA DISPLAY PANEL AND PLASMA DISPLAY APPARATUS

(76) Inventors: Kirack PARK, Gumi-city (KR); Seonghwan Ryu, Gumi-city (KR); Jaeyoung Park, Gumi-city (KR)

Correspondence Address: KED & ASSOCIATES, LLP, P.O. Box 221200, Chantilly, VA, 20153-1200, US

(21) Appl. No.: 12/510,516

(22) Filed: Jul. 28, 2009

(30) Foreign Application Priority Data
Oct. 30, 2008 (KR) 10-2008-0107126

(51) Int. Cl. G09G 3/28

(52) U.S. Cl. 345/60

(57) ABSTRACT

A plasma display panel and a plasma display apparatus including the same are provided. The plasma display panel includes a front substrate on which a scan electrode and a sustain electrode are positioned substantially parallel to each other, a rear substrate on which an address electrode is positioned to cross the scan electrode and the sustain electrode, and a discharge gas filled in a space between the front substrate and the rear substrate. The scan electrode and the sustain electrode are ITO-less electrodes. The discharge gas contains a nitrogen gas (N₂).

This application claims the benefit of Korea Patent Application No. 10-2008-0107126 filed on Oct. 30, 2008, the entire contents of which is incorporated herein by reference for all purposes as if fully set forth herein.

1. Field

Embodiments relate to a plasma display panel and a plasma display apparatus including the same.

2. Description of the Background Art

A plasma display apparatus includes a plasma display panel. The plasma display panel includes a phosphor layer inside discharge cells partitioned by barrier ribs and a plurality of electrodes.

When driving signals are applied to the electrodes of the plasma display panel, a discharge occurs inside the discharge cells. More specifically, when the discharge occurs in the discharge cells by applying the driving signals to the electrodes, a discharge gas filled in the discharge cells generates vacuum ultraviolet rays, which thereby cause phosphors between the barrier ribs to emit visible light. An image is displayed on the screen of the plasma display panel using the visible light.

### SUMMARY

In one aspect, there is a plasma display panel comprising a front substrate on which a scan electrode and a sustain electrode are positioned substantially parallel to each other, the scan electrode and the sustain electrode being ITO-less electrodes, a rear substrate on which an address electrode is positioned to cross the scan electrode and the sustain electrode, and a discharge gas filled in a space between the front substrate and the rear substrate, the discharge gas containing a nitrogen gas (N₂).

In another aspect, there is a plasma display apparatus comprising a plasma display panel including a front substrate on which a scan electrode and a sustain electrode are positioned substantially parallel to each other, a rear substrate opposite the front substrate, and a discharge gas filled in a space between the front substrate and the rear substrate, and a driver that supplies a negative scan voltage, a sustain voltage, a scan reference signal, and a sustain reference signal to the scan electrode, wherein the scan electrode and the sustain electrode are ITO-less electrodes, wherein the discharge gas contains a nitrogen gas (N₂).

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates an exemplary configuration of a plasma display apparatus according to an embodiment;

FIG. 2 illustrates an exemplary structure of a plasma display panel according to an embodiment;

FIG. 3 illustrates an exemplary structure of a frame for achieving a gray level of an image;

FIG. 4 illustrates a cross-section structure of a scan electrode and a sustain electrode;

FIGS. 5 to 9 illustrate a shape of a scan electrode and a sustain electrode;

FIG. 10 is a diagram for comparing an ITO electrode with an ITO-Less electrode;

FIGS. 11 to 15 illustrate an exemplary method of driving a plasma display panel;

FIGS. 16 to 19 illustrate luminances of red, green, blue, and white images depending on changes in a content of N₂ added to a discharge gas; and

FIGS. 20 to 24 illustrate changes in a sustain voltage depending on changes in a N₂ content.

FIGS. 25 to 28 illustrate a barrier rib and a phosphor layer on the barrier rib;

FIGS. 29 and 30 illustrate a luminance and a luminance remaining percentage of an image depending on a N₂ content in a discharge gas;

FIGS. 31 and 32 illustrate an exemplary method of forming a phosphor layer;

FIGS. 33 and 34 are diagrams for explaining heights of a barrier rib and a phosphor layer;

FIGS. 35 and 36 illustrate another structure of a phosphor layer; and

FIGS. 37 to 39 illustrate a black layer.

### DETAILED DESCRIPTION OF PREFERRED EMBODIMENTS

Reference will now be made in detail embodiments of the invention examples of which are illustrated in the accompanying drawings.

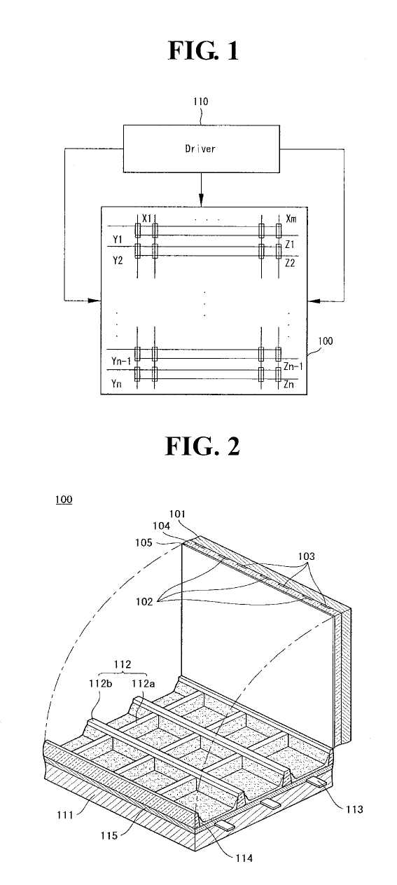

FIG. 1 illustrates an exemplary configuration of a plasma display apparatus according to an embodiment.

As shown in FIG. 1, the plasma display apparatus according to the exemplary embodiment includes a plasma display panel 100 and a driver 110.

The plasma display panel 100 may include scan electrodes Y1 to Yn and sustain electrodes Z1 to Zn positioned substantially parallel to each other and address electrodes X1 to Xm crossing the scan electrodes Y1 to Yn and the sustain electrodes Z1 to Zn. A space inside the plasma display panel 100 may be filled with a discharge gas containing nitrogen gas (N₂).

The driver 110 may supply driving signals to at least one of the scan electrodes Y1 to Yn, the sustain electrodes Z1 to Zn, or the address electrodes X1 to Xm and allow an image to be displayed on the screen of the plasma display panel 100. The driver 110 may supply a negative scan voltage −Vy, a sustain voltage Vs, a scan reference voltage Vsc, and a sustain reference voltage Vzb to the scan electrodes Y1 to Yn.

Although FIG. 1 shows the driver 110 formed in the form of a signal board, the driver 110 may be formed in the form of a plurality of boards depending on the electrodes on the plasma display panel 100. For example, the driver 110 may include a first driver (not shown) for driving the scan electrodes Y1 to Yn, a second driver (not shown) for driving the sustain electrodes Z1 to Zn, and a third driver (not shown) for driving the address electrodes X1 to Xm.

FIG. 2 illustrates an exemplary structure of a plasma display panel according to an embodiment.

As shown in FIG. 2, the plasma display panel may include a front substrate 101, on which a scan electrode 102 and a sustain electrode 103 are formed substantially parallel to each other and a rear substrate 111 on which an address electrode 113 is formed to cross the scan electrode 102 and the sustain electrode 103.

An upper dielectric layer 104 may be formed on the scan electrode 102 and the sustain electrode 103 to limit a discharge current of the scan electrode 102 and the sustain electrode 103 and to provide insulation between the scan electrode 102 and the sustain electrode 103.

A protective layer 105 may be formed on the upper dielectric layer 104 to facilitate discharge conditions. The protective layer 105 may be formed of a material having a high secondary electron emission coefficient, for example, magnesium oxide (MgO).

A lower dielectric layer 115 may be formed on the address electrode 113 to provide insulation between the address electrodes 113.

Barrier ribs 112 of a stripe type, a well type, a delta type, a honeycomb type, etc. may be formed on the lower dielectric layer 115 to partition discharge spaces (i.e., discharge cells). Hence, a first discharge cell emitting red light, a second discharge cell emitting blue light, and a third discharge cell emitting green light, etc. may be formed between the front substrate 101 and the rear substrate 111.

Each discharge cell portioned by the barrier ribs 112 may be filled with a discharge gas. It may be preferable that the discharge gas contains nitrogen gas (N₂).

A phosphor layer 114 may be formed inside the discharge cells to emit visible light for an image display during an address discharge. For example, first, second, and third phosphor layers that respectively generate red, blue, and green light may be formed inside the discharge cells.

When a predetermined signal is supplied to at least one of the scan electrode 102, the sustain electrode 103, and the address electrode 113, a discharge may occur inside the discharge cell. The discharge may allow the discharge gas filled in the discharge cell to generate ultraviolet rays. The ultraviolet rays may be incident on phosphor particles of the phosphor layer 114, and then the phosphor particles may emit visible light. Hence, an image may be displayed on the screen of the plasma display panel.

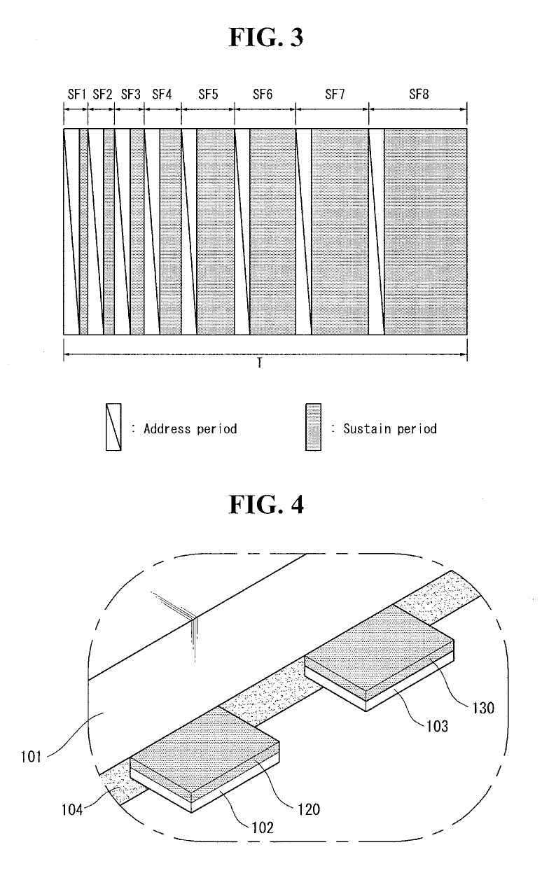

FIG. 3 illustrates an exemplary structure of a frame for achieving a gray level of an image.

As shown in FIG. 3, a frame may include a plurality of subfields. Each of the plurality of subfields may be divided into an address period and a sustain period. During the address period, the discharge cells not to generate a discharge may be selected or the discharge cells to generate a discharge may be selected. During the sustain period, a gray scale may be achieved depending on the number of discharges.

For example, if an image with 256-gray levels is to be displayed, as shown in FIG. 3, a frame may be divided into 8 subfields SF1 to SF8. Each of the 8 subfields SF1 to SF8 may include an address period and a sustain period.

The number of sustain signals supplied during the sustain period may determine a gray level of each of the subfields. For example, in such a method of setting a gray level of a first subfield at 2⁰ and a gray level of a second subfield at 2¹, the sustain period increases in a ratio of 2ⁿ (where, n=0, 1, 2, 3, 4, 5, 6, 7) in each of the subfields. Hence, various gray levels of an image may be achieved by controlling the number of sustain signals supplied during the sustain period of each subfield depending on a gray level of each subfield.

Although FIG. 3 shows that one frame includes 8 subfields, the number of subfields constituting a frame may vary. For example, a frame may include 10 or 12 subfields. Further, although FIG. 3 shows that the subfields of the frame are arranged in increasing order of gray level weight, the subfields may be arranged in decreasing order of gray level weight or may be arranged regardless of gray level weight.

At least one of a plurality of subfields of a frame may be a selective erase subfield or a selective write subfield.

If a frame includes at least one selective erase subfield and at least one selective write subfield, it may be preferable that a first subfield of a plurality of subfields of the frame is a selective write subfield and the other subfields are selective erase subfields. Alternatively, all the subfields of the frame may be selective erase subfields.

In the selective erase subfield, the discharge cell to which a data signal is supplied during an address period is turned off during a sustain period following the address period. In the selective write subfield, the discharge cell to which a data signal is supplied during an address period is turned on during a sustain period following the address period.

The selective write subfield may include a reset period for initializing the discharge cells, an address period, and a sustain period.

FIG. 4 illustrates a cross-section structure of the scan electrode and the sustain electrode.

As shown in FIG. 4, the scan electrode 102 and the sustain electrode 103 may be an ITO-less electrode. Namely, the scan electrode 102 and the sustain electrode 103 may be a bus electrode in which a transparent electrode is omitted.

The scan electrode 102 and the sustain electrode 103 may be a silver electrode formed of silver (Ag). Alternatively, the scan electrode 102 and the sustain electrode 103 may be a metal electrode having a single-layered structure.

Black layers 120 and 130 may be formed between the scan and sustain electrodes 102 and 103 and the front substrate 101.

The scan electrode 102 and the sustain electrode 103 may be formed of a metal material with excellent electrical conductivity, that is easy to mold, for example, Ag, Au, Cu, Al.

The black layers 120 and 130 may be formed of a material having a relatively high degree of darkness. For example, the black layers 120 and 130 may be formed of at least one of Co and Ru. The black layers 120 and 130 may reduce a reflectance of the panel to thereby improve contrast characteristics of an image.

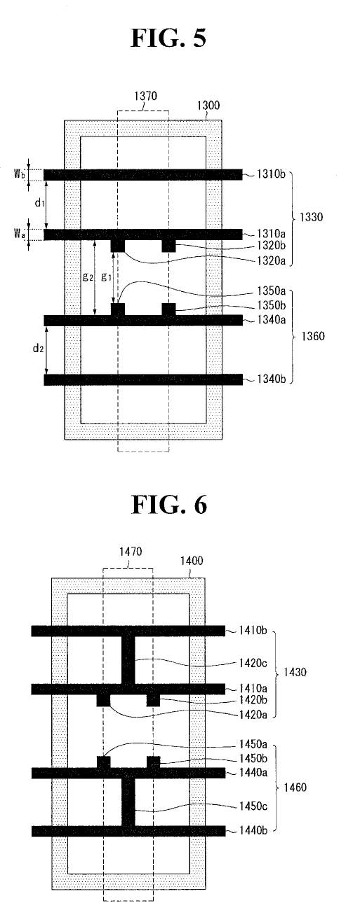

FIGS. 5 to 9 illustrate a shape of the scan electrode and the sustain electrode.

At least one of a scan electrode 1330 or a sustain electrode 1360 may include at least one line portion. In FIG. 5, the scan electrode 1330 includes two line portions 1310a and 1310b, and the sustain electrode 1360 includes two line portions 1340a and 1340b.

Each of the line portions 1310a, 1310b, 1340a and 1340b may cross an address electrode 1370 inside a discharge cell partitioned by a barrier rib 1300.

The line portions 1310a, 1310b, 1340a and 1340b may be spaced apart from one another with a predetermined distance therebetween. In FIG. 5, the first and second line portions 1310a and 1310b of the scan electrode 1330 are spaced apart from each other with a distance d1 therebetween. The first and second line portions 1340a and 1340b of the sustain electrode 1360 are spaced apart from each other with a distance d2 therebetween. The distance d1 may be equal to or different from the distance d2.

A shape of the scan electrode 1330 may be symmetrical or asymmetrical to a shape of the sustain electrode 1360 inside the discharge cell. For example, while the scan electrode 1330 may include three line portions, the sustain electrode 1360 may include two line portions.

The number of line portions in the scan and sustain electrodes 1330 and 1360 may vary. For example, the scan electrode 1330 or the sustain electrode 1360 may include 4 or 5 line portions.

At least one of the scan electrode 1330 or the sustain electrode 1360 may include at least one projection portion. In FIG. 5, the scan electrode 1330 includes two projection portions 1320a and 1320b, and the sustain electrode 1360 includes two projection portions 1350a and 1350b.

The projection portions 1320a and 1320b of the scan electrode 1330 may project from the first line portion 1310a, and the projection portions 1350a and 1350b of the sustain electrode 1360 may project from the first line portion 1340a. The projection portions 1320a, 1320b, 1350a and 1350b may be substantially parallel to the address electrode 1370.

An interval g1 between the scan and sustain electrodes 1330 and 1360 at the projection portions 1320a, 1320b, 1350a and 1350b is shorter than an interval g2 between the scan and sustain electrodes 1330 and 1360 in the discharge cell. Accordingly, a firing voltage of a discharge generated between the scan electrode 1330 and the sustain electrode 1360 may be lowered.

Although FIG. 5 shows that the scan electrode 1330 and the sustain electrode 1360 each include two projection portions, each of the scan electrode 1330 and the sustain electrode 1360 may include three projection portions or four projection portions.

A width of at least one of the plurality of line portions 1310a, 1310b, 1340a and 1340b may be different from widths of the other line portions.

A scan electrode 1430 and a sustain electrode 1460 may include a connection portion for connecting at least two line portions. As shown in FIG. 6, the scan electrode 1430 includes a connection portion 1420c for connecting first and second line portions 1410a and 1410b to each other, and the sustain electrode 1460 includes a connection portion 1450c for connecting first and second line portions 1440a and 1440b to each other. The connection portions 1420c and 1450c may allow a discharge occurring between the scan electrode 1430 and the sustain electrode 1460 to be easily diffused inside a discharge cell partitioned by a barrier rib 1400.

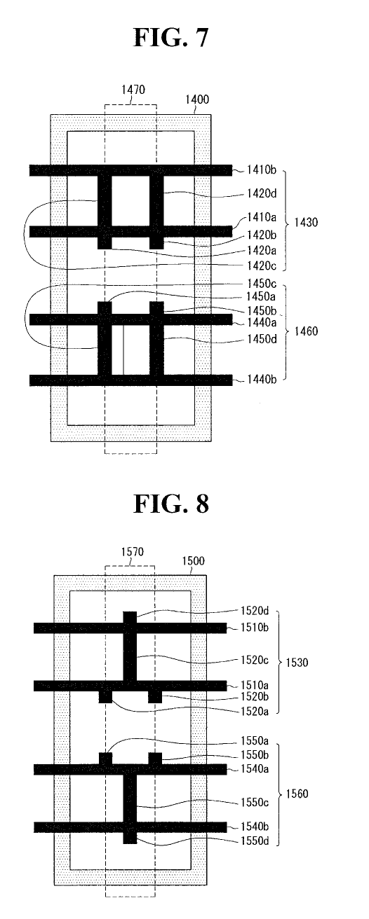

As shown in FIG. 7, two connection portions 1420c and 1420d may be used to connect the first and second line portions 1410a and 1410b of the scan electrode 1430. Namely, the number of connection portions may be changed variously.

As shown in FIG. 8, at least one of a plurality of projection portions 1520a, 1520b and 1520d of a scan electrode 1530 and at least one of a plurality of projection portions 1550a, 1550b and 1550d of a sustain electrode 1560 may project toward a first direction. At least one of the projection portions 1520a, 1520b and 1520d of the scan electrode 1530 and at least one of the projection portions 1550a, 1550b and 1550d of the sustain electrode 1560 may project toward a second direction different from the first direction.

In the exemplary embodiment, the projection portions 1520a, 1520b, 1550a, and 1550b projecting toward the first direction are referred to as a first projection portion, and the projection portions 1520d and 1550d projecting toward the second direction are referred to as a second projection portion. The first direction may be opposite to the second direction. For example, the first direction may be a direction toward the center of a discharge cell, and the second direction may be a direction opposite the center direction of the discharge cell.

The projection portions 1520c and 1550c projecting toward the second direction allow a discharge to be more widely diffused inside the discharge cell.

FIG. 8 shows that the scan and sustain electrodes 1530 and 1560 each include one second projection portion, but each of the scan and sustain electrodes 1530 and 1560 may include two second projection portions 1520d, 1520e, 1550d and 1550e.

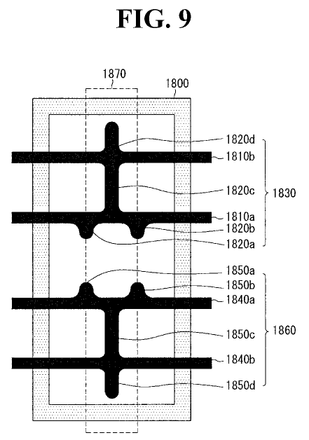

A projection portion may include a portion with curvature. As shown in FIG. 9, at least one of a plurality of projection portions 1820a, 1820b, 1820d, 1850a, 1850b, and 1850d may include a portion with curvature. More specifically, a tip portion of at least one of the projection portions 1820a, 1820b, 1820d, 1850a, 1850b, and 1850d may have curvature. Further, a portion where the projection portions 1820a, 1820b, 1820d, 1850a, 1850b and 1850d adjoin line portions 1810a, 1810b, 1840a and 1840b may have curvature. A portion where the line portions 1810a, 1810b, 1840a and 1840b adjoin connection portions 1820c and 1850c may have curvature.

As a result, a scan electrode 1830 and a sustain electrode 1860 can be easily manufactured. Further, wall charges can be prevented from being excessively accumulated on a specific portion during a driving of the panel, and thus a driving stability can be improved.

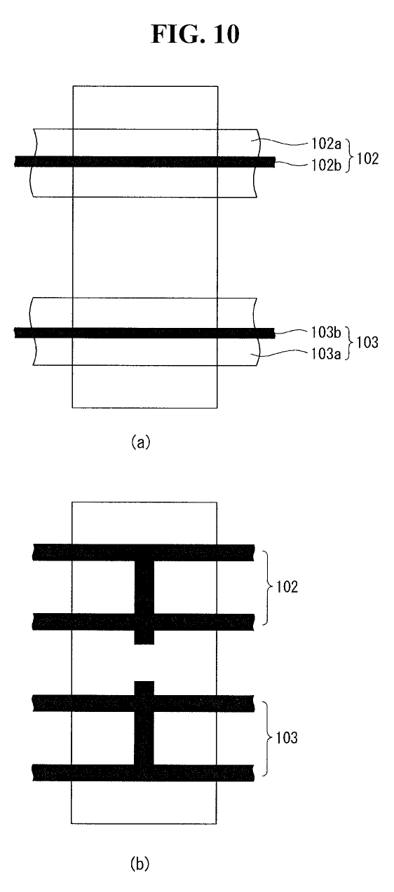

FIG. 10 is a diagram for comparing an indium-tin-oxide (ITO) electrode with an ITO-less electrode.

As shown in FIG. 10, (a) shows a scan electrode 102 and a sustain electrode 103 each including a transparent electrode (i.e., an ITO electrode) and a bus electrode, and (b) shows a scan electrode 102 and a sustain electrode 103 being ITO-less electrodes.

In (a) of FIG. 10, because the scan electrode 102 and the sustain electrode 103 each include transparent electrode 102a and 103a and bus electrode 102b and 103b, even if the bus electrode 102b and 103b occupy a relatively small area, electrical conductivity of the scan electrode 102 and the sustain electrode 103 is not reduced. Accordingly, an excessive reduction in the driving efficiency may be prevented, and an aperture ratio may be kept at a high value.

On the other hand, in (b) of FIG. 10, because a transparent electrode is omitted in the scan electrode 102 and the sustain electrode 103, a firing voltage between the scan electrode 102 and the sustain electrode 103 in (b) of FIG. 10 is greater than a firing voltage between the scan electrode 102 and the sustain electrode 103 in (a) of FIG. 10. Further, an aperture ratio and a luminance in (b) of FIG. 10 are smaller than those in (a) of FIG. 10.

To lower the firing voltage between the scan electrode 102 and the sustain electrode 103 in (b) of FIG. 10, electrical conductivity of the scan electrode 102 and the sustain electrode 103 has to increase by sufficiently widening areas of the scan electrode 102 and the sustain electrode 103. However, in this case, the aperture ratio and the luminance may be excessively reduced. Further, when the areas of the scan electrode 102 and the sustain electrode 103 decrease so as to increase the aperture ratio, the firing voltage between the scan electrode 102 and the sustain electrode 103 may excessively increase.

Because the ITO-less electrode in (b) of FIG. 10 does not use a transparent electrode material (i.e., an ITO material), the manufacturing cost may be reduced as compared with the electrodes in (a) of FIG. 10, and a manufacturing process may be simplified.

Therefore, the firing voltage between the scan electrode 102 and the sustain electrode 103 has to be lowered and the aperture ratio and the luminance have to increase, so as to use the ITO-less electrode having advantages of the simple manufacturing process and the low manufacturing cost.

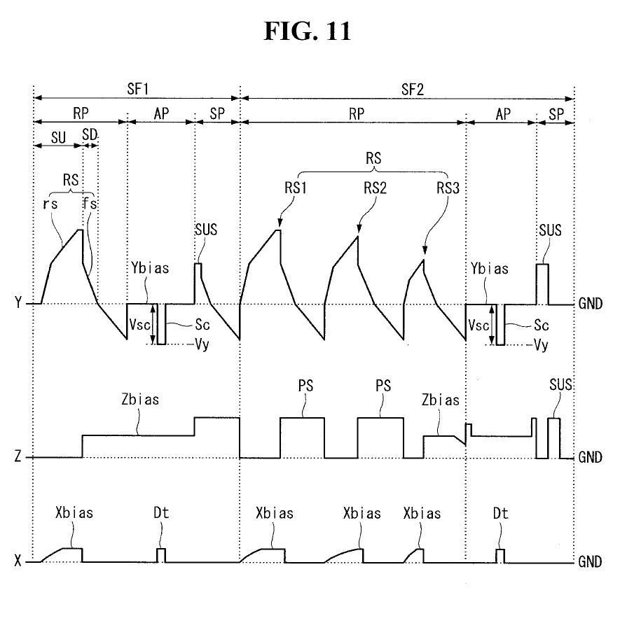

FIGS. 11 to 15 illustrate an exemplary method of driving the plasma display panel. Driving signals in FIGS. 11 to 15 may be supplied by the driver 110 of FIG. 1.

As shown in FIG. 11, a reset signal RS may be supplied to the scan electrode Y during a reset period RP for initialization of a first subfield SF1 of a plurality of subfields of a frame. The reset signal RS may include a rising signal rs with a rising voltage and a falling signal fs with a falling voltage.

More specifically, the rising signal rs may be supplied to the scan electrode Y during a setup period SU of the reset period RP, and the falling signal fs may be supplied to the scan electrode Y during a set-down period SD following the setup period SU. The rising signal rs may generate a weak dark discharge (i.e., a setup discharge) inside the discharge cells. Hence, the remaining wall charges may be uniformly distributed inside the discharge cells. The falling signal fs may generate a weak erase discharge (i.e., a set-down discharge) inside the discharge cells. Hence, the remaining wall charges may be uniformly distributed inside the discharge cells to the extent that an address discharge occurs stably.

During the reset period RP, an address reference signal Xbias may be supplied to the address electrode X. The supply of the address reference signal Xbias may reduce a voltage difference between the scan electrode Y and the address electrode X and may prevent an opposite discharge from occurring between the scan electrode Y and the address electrode X. Hence, contrast characteristics may be improved, and a generation of bright defect may be suppressed.

For example, in case the scan electrode and the sustain electrode are ITO-less electrodes as shown in (b) of FIG. 10, a firing voltage between the scan electrode and the sustain electrode may increase. Hence, a voltage between the scan electrode and the sustain electrode during a drive may increase.

If in the ITO-less electrode structure, an address reference signal is not supplied to the address electrode during a reset period and a voltage of the address electrode is kept at a ground level voltage GND during the reset period, an opposite discharge may strongly occur between the scan electrode and the address electrode because of a high voltage of the scan electrode. Hence, contrast characteristics may be reduced, and a generation of bright defect may sharply increase.

On the other hand, when in the ITO-less electrode structure, an address reference signal is supplied to the address electrode during a reset period, a reduction in the contrast characteristics may be prevented and the generation of bright defect may be suppressed because a voltage difference between the scan electrode and the address electrode is reduced.

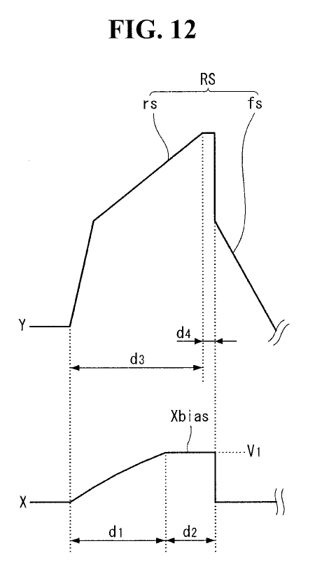

As shown in FIG. 12, the address reference signal Xbias may include a first period d1 during which a voltage of the address electrode X gradually rises and a second period d2 during which a voltage of the address electrode X is kept at a maximum voltage V1 of the address reference signal Xbias. During the first period d1, the address electrode X may be floated. Hence, a voltage of the address electrode X may gradually rise in synchronization with the reset signal RS supplied to the scan electrode Y.

The reset signal RS supplied to the scan electrode Y may include a third period d3 during which a voltage of the scan electrode Y gradually rises and a fourth period d4 during which a voltage of the scan electrode Y is kept at a maximum voltage of the reset signal RS.

The maximum voltage V1 of the address reference signal Xbias may excessively increase by the floating of the address electrode X and thus a reset discharge may occur unstably. It may be preferable that a length of the second period d2 of the address reference signal Xbias is longer than a length of the fourth period d4 of the reset signal RS so as to prevent the unstable generation of the reset discharge.

The maximum voltage V1 of the address reference signal Xbias may be substantially equal to a voltage of a data signal Dt supplied during an address period AP following the reset period RP.

During the address period AP, a scan reference signal Ybias having a voltage greater than a minimum voltage of the falling signal fs may be supplied to the scan electrode Y. A voltage magnitude Vsc of the scan reference signal Ybias is a difference between a minimum voltage −Vy of a scan signal Sc and a voltage of the scan reference signal Ybias. The scan signal Sc falling from the scan reference signal Ybias to the negative scan voltage −Vy may be supplied to the scan electrode Y.

A pulse width of a scan signal supplied to the scan electrode during an address period of at least one subfield of a frame may be different from pulse widths of scan signals supplied during address periods of the other subfields of the frame. A pulse width of a scan signal in a subfield may be greater than a pulse width of a scan signal in a next subfield. For example, a pulse width of the scan signal may be gradually reduced in the order of 2.6 μs, 2.3 μs, 2.1 μs, 1.9 μs, etc. or may be reduced in the order of 2.6 μs, 2.3 μs, 2.3 μs, 2.1 μs, . . . , 1.9 μs, 1.9 μs, etc. in the successively arranged subfields.

When the scan signal Sc is supplied to the scan electrode Y, the data signal Dt corresponding to the scan signal Sc may be supplied to the address electrode X. As a voltage difference between the scan signal Sc and the data signal Dt is added to a wall voltage resulting from wall charges produced during the reset period RP, an address discharge may occur inside the discharge cells to which the data signal Dt is supplied.

During a sustain period SP following the address period AP, a sustain signal SUS may be supplied to the scan electrode Y. As the wall voltage inside the discharge cells selected by the generation of the address discharge is added to a sustain voltage of the sustain signal SUS, every time the sustain signal SUS is supplied, a sustain discharge (i.e., a display discharge) may occur between the scan electrode Y and the sustain electrode Z.

During the sustain period SP, a sustain reference signal Zbias may be supplied to the sustain electrode Z. The sustain reference signal Zbias may be supplied to the sustain electrode Z during the reset, address, and sustain periods.

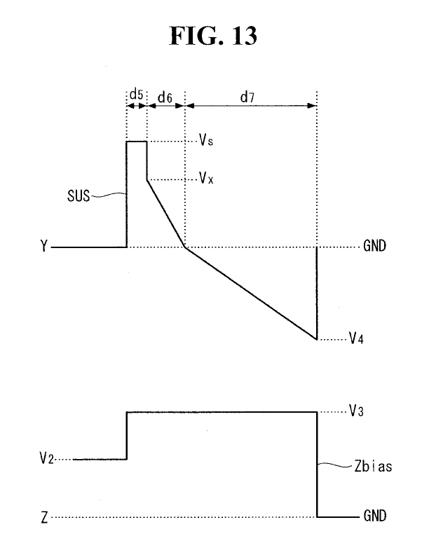

As shown in FIG. 13, the sustain signal SUS may include a fifth period d5 during which a voltage of the scan electrode Y is kept at the maximum voltage Vs of the sustain signal SUS, a sixth period d6 during which a voltage of the scan electrode Y gradually falls from a predetermined voltage Vx less than the maximum voltage Vs with a first slope, and a seventh period d7 during which a voltage of the scan electrode Y falls from the predetermined voltage Vx to a minimum voltage V4 of the sustain signal SUS with a second slope smaller than the first slope. The predetermined voltage Vx may be less than the sustain voltage Vs and may be greater than the ground level voltage GND. The minimum voltage V4 of the sustain signal SUS may be substantially equal to a minimum voltage of the falling signal fs.

As above, when the sustain signal SUS includes the above three periods d5, d6, and d7, a noise and an electromagnetic interference (EMI) may be reduced.

A voltage V3 of the sustain reference signal Zbias in the sustain period may be greater than a voltage V2 of the sustain reference signal Zbias in the address period. Preferably, the voltage V3 of the sustain reference signal Zbias in the sustain period may be equal to the sustain voltage Vs. In this case, the sustain discharge may occur more stably during the sustain period of the first subfield SF1.

During a reset period RP of a second subfield SF2 following the first subfield SF1, a plurality of reset signals may be supplied to the scan electrode Y. FIG. 11 shows that three reset signals RS1, RS2, and RS3 are supplied to the scan electrode Y.

When the plurality of reset signals are supplied to the scan electrode Y during the reset period RP of the second subfield SF2, a reset operation in the reset period RP of the second subfield SF2 may be efficiently performed even if the discharge in the sustain period of the first subfield SF1 occurs unstably. Hence, the entire discharge of the panel may be stabilized.

Because the sustain signals SUS is supplied to only the scan electrode Y and the sustain reference signal Zbias is supplied to the sustain electrode during the sustain period of the first subfield SF1, a relatively small number of sustain discharges are generated during the sustain period of the first subfield SF1. Hence, a distribution state of wall charges after the sustain period of the first subfield SF1 may be unstable. Accordingly, a discharge generated after the first subfield SF1 may stabilized by supplying the plurality of reset signals to the scan electrode Y during the reset period RP of the second subfield SF2.

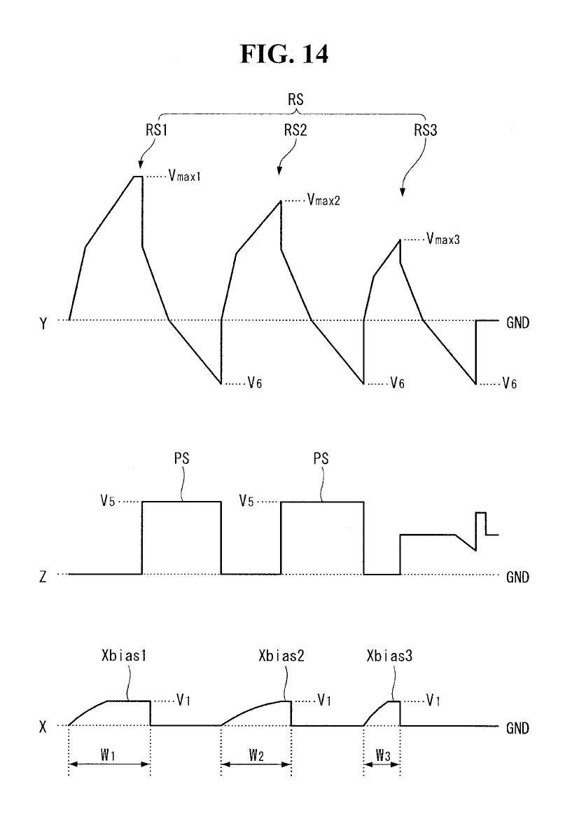

As shown in FIG. 14, in the reset period RP of the second subfield SF2, a maximum voltage Vmax1 of the first reset signal RS1 may be greater than a maximum voltage Vmax2 of the second reset signal RS2, and the maximum voltage Vmax2 of the second reset signal RS2 may be greater than a maximum voltage Vmax3 of the third reset signal RS3. The reset signals RS1, RS2, and RS3 may be supplied in decreasing order of the maximum voltages of the reset signals RS1, RS2, and RS3.

As above, when the reset signals RS1, RS2, and RS3 are supplied in decreasing order of the maximum voltages of the reset signals RS1, RS2, and RS3, a reset discharge may occur more stably. Further, an amount of light generated during the reset period decreases, and thus the contrast characteristics may be improved.

More specifically, the supply of the first reset signal RS1 having the greatest maximum voltage may reset a state of wall charges distributed inside the discharge cells. Accordingly, even if the maximum voltage of the second reset signal RS2 following the first reset signal RS1 is less than the maximum voltage of the first reset signal RS1, a state of wall charges distributed inside the discharge cells may be uniform through the second reset signal RS2. If the maximum voltage of the second reset signal RS2 is equal to or greater than the maximum voltage of the first reset signal RS1, an amount of light generated during the reset period may increase. Hence, the contrast characteristics may worsen. Minimum voltages V6 of the reset signals RS1, RS2, and RS3 may be substantially equal to one another.

A positive polarity signal PS may be supplied to the sustain electrode Z during a supply of falling signals of the first and second reset signals RS1 and RS2. The supply of the positive polarity signal PS may stabilize a set-down discharge resulting from the falling signals of the first and second reset signals RS1 and RS2.

A voltage V5 of the positive polarity signal PS may be substantially equal to the sustain voltage Vs of the sustain signal SUS.

When the first, second, and third reset signals RS1, RS2, and RS3 are supplied to the scan electrode Y, first, second, and third address reference signals Xbias1, Xbias2, and Xbias3 respectively overlapping the first, second, and third reset signals RS1, RS2, and RS3 may be supplied to the address electrode X.

A pulse width of the address reference signal may be adjusted depending on a magnitude of the maximum voltage of the corresponding reset signal. For example, a pulse width W1 of the first address reference signal Xbias1 overlapping the first reset signal RS1 having the greatest maximum voltage Vmax1 may be greater than a pulse width W2 of the second address reference signal Xbias2 overlapping the second reset signal RS2 whose the maximum voltage Vmax2 is less than the maximum voltage Vmax1 of the first reset signal RS1. The pulse width W2 of the second address reference signal Xbias2 overlapping the second reset signal RS2 may be greater than a pulse width W3 of the third address reference signal Xbias3 overlapping the third reset signal RS3 whose the maximum voltage Vmax3 is less than the maximum voltage Vmax2 of the second reset signal RS2.

In the reset and address periods of the second subfield SF2, a sustain reference signal Zbias supplied to the sustain electrode Z may include a falling portion with a gradually falling voltage.

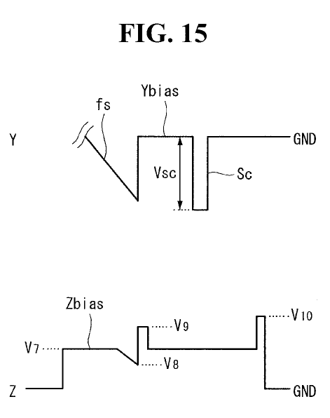

More specifically, as shown in FIG. 15, in the second subfield SF2, the sustain reference signal Zbias may overlap a falling signal of a last reset signal (i.e., the third reset signal RS3) supplied during the reset period and the address period. The sustain reference signal Zbias may include a falling portion gradually falling from a seventh voltage V7 to an eighth voltage V8 during a supply of a falling signal fs of the third reset signal RS3 in a boundary between the reset and address periods. In this case, a noise and EMI resulting from the falling signal fs of the third reset signal RS3 may be reduced.

The sustain reference signal Zbias may rise from the eighth voltage V8 to a ninth voltage V9 greater than the seventh voltage V7 after the falling portion and then may be kept at the ninth voltage V9 for a predetermined period of time. Then, the sustain reference signal Zbias may fall from the ninth voltage V9 to the the seventh voltage V7. The sustain reference signal Zbias may rise from the seventh voltage V7 to a tenth voltage V10 in an end of the address period. The tenth voltage V10 may be substantially equal to the ninth voltage V9, and the ninth voltage V9 and the tenth voltage V10 may be substantially equal to the sustain voltage Vs.

During a sustain period SP of the second subfield SF2, sustain signals SUS may be alternately supplied to the scan electrode Y and the sustain electrode Z.

As described above, in the ITO-less electrode structure shown in (b) of FIG. 10, the aperture ratio and the luminance may be reduced. It may be preferable that a nitrogen gas (N₂) may be added to the discharge gas so as to compensate for a reduction in the luminance in the ITO-less electrode structure.

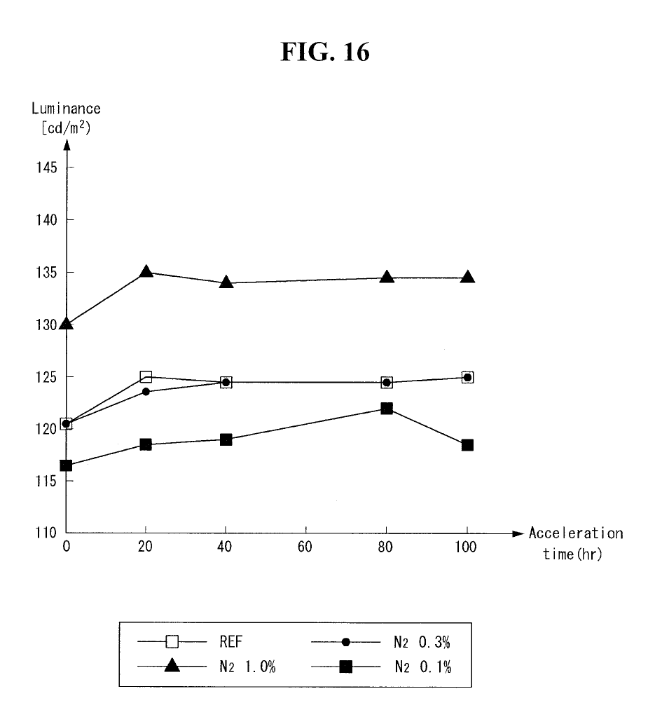

FIGS. 16 to 19 illustrate luminances of red, green, blue, and white images depending on changes in a content of N₂ added to a discharge gas.

Experimental conditions for measurement of a luminance are as follows:

1. A scan electrode and a sustain electrode have an ITO-less electrode structure.

2. A height of a barrier rib is approximately 120 μm.

3. A thickness of an upper dielectric layer is approximately 20 μm.

4. A thickness of a lower dielectric layer is approximately 10 μm.

5. A sustain voltage Vs is approximately 197 V.

6. A negative scan voltage −Vy is approximately −80 V.

7. A voltage of a sustain reference signal Zbias is approximately 140 V, and more specifically, the voltage of the sustain reference signal Zbias in an address period is approximately 140 V.

8. A voltage magnitude of a scan reference signal Ybias is approximately 135 V.

9. A discharge gas includes 15% of xenon (Xe) based on total weight of the discharge gas.

10. A pressure of the discharge gas is 370 torr.

11. A N₂ content in the discharge gas changes to 0%, 0.1%, 0.3%, or 1.0% under the above ten conditions.

A method for measuring the luminance is as follows.

While full red, full green, full blue, and full white images are displayed on a panel of a finished state fabricated in a production line for 0 to 120 hours, a luminance of each image is measured. A display time of each image on the panel is referred to as an acceleration time.

FIG. 16 is a graph showing a luminance of a full red image depending on changes in a N₂ content.

As shown in FIG. 16, when the N₂ content is 0 (i.e., N₂ is not added to the discharge gas), a luminance of the full red image before the panel is not accelerated is approximately 120.5 cd/m². After the acceleration time of about 20 hours elapsed, the luminance of the full red image is approximately 125 cd/m². After the acceleration time of about 40 to 80 hours elapsed, the luminance of the full red image is approximately 124.5 cd/m². After the acceleration time of about 100 hours elapsed, the luminance of the full red image is approximately 124.5 cd/m².

When the N₂ content based on total weight of the discharge gas is 0.1%, the luminance of the full red image before the panel is not accelerated is approximately 116.5 cd/m². After the acceleration time of about 20 hours elapsed, the luminance of the full red image is approximately 118.5 cd/m². After the acceleration time of about 40 hours elapsed, the luminance of the full red image is approximately 119 cd/m². After the acceleration time of about 80 hours elapsed, the luminance of the full red image is approximately 122 cd/m². After the acceleration time of about 100 hours elapsed, the luminance of the full red image is approximately 118.5 cd/m².

When the N₂ content based on total weight of the discharge gas is 0.3%, the luminance of the full red image before the panel is not accelerated is approximately 120.5 cd/m². After the acceleration time of about 20 hours elapsed, the luminance of the full red image is approximately 123.5 cd/m². After the acceleration time of about 40 to 80 hours elapsed, the luminance of the full red image is approximately 124.5 cd/m². After the acceleration time of about 100 hours elapsed, the luminance of the full red image is approximately 125 cd/m².

When the N₂ content based on total weight of the discharge gas is 1.0%, the luminance of the full red image before the panel is not accelerated is approximately 130 cd/m². After the acceleration time of about 20 hours elapsed, the luminance of the full red image is approximately 135 cd/m². After the acceleration time of about 40 hours elapsed, the luminance of the full red image is approximately 134 cd/m². After the acceleration time of about 80 to 100 hours elapsed, the luminance of the full red image is approximately 134.5 cd/m².

It can be seen from FIG. 16 that the luminance of the red image considerably increases when the N₂ content based on total weight of the discharge gas is 1.0%.

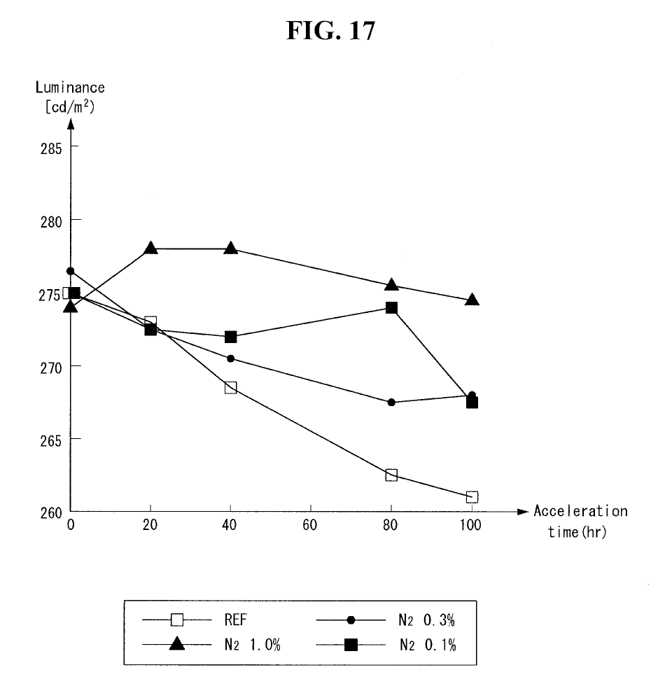

FIG. 17 is a graph showing a luminance of a full green image depending on changes in a N₂ content.

As shown in FIG. 17, when the N₂ content is 0 (i.e., N₂ is not added to the discharge gas), a luminance of the full green image before the panel is not accelerated is approximately 275 cd/m². After the acceleration time of about 20 hours elapsed, the luminance of the full green image is approximately 273 cd/m². After the acceleration time of about 40 hours elapsed, the luminance of the full green image is approximately 268.5 cd/m². After the acceleration time of about 80 hours elapsed, the luminance of the full green image is approximately 262.5 cd/m². After the acceleration time of about 100 hours elapsed, the luminance of the full green image is approximately 261 cd/m².

When the N₂ content based on total weight of the discharge gas is 0.1%, the luminance of the full green image before the panel is not accelerated is approximately 275 cd/m². After the acceleration time of about 20 hours elapsed, the luminance of the full green image is approximately 272.5 cd/m². After the acceleration time of about 40 hours elapsed, the luminance of the full green image is approximately 272 cd/m². After the acceleration time of about 80 hours elapsed, the luminance of the full green image is approximately 274 cd/m². After the acceleration time of about 100 hours elapsed, the luminance of the full green image is approximately 267.5 cd/m²

When the N₂ content based on total weight of the discharge gas is 0.3%, the luminance of the full green image before the panel is not accelerated is approximately 276.5 cd/m². After the acceleration time of about 20 hours elapsed, the luminance of the full green image is approximately 271.5 cd/m². After the acceleration time of about 40 hours elapsed, the luminance of the full green image is approximately 270.5 cd/m². After the acceleration time of about 80 hours elapsed, the luminance of the full green image is approximately 267.5 cd/m². After the acceleration time of about 100 hours elapsed, the luminance of the full green image is approximately 268 cd/m²

When the N₂ content based on total weight of the discharge gas is 1.0%, the luminance of the full green image before the panel is not accelerated is approximately 274 cd/m². After the acceleration time of about 20 hours elapsed, the luminance of the full green image is approximately 278 cd/m². After the acceleration time of about 40 hours elapsed, the luminance of the full green image is approximately 278 cd/m². After the acceleration time of about 80 hours elapsed, the luminance of the full green image is approximately 275.5 cd/m². After the acceleration time of about 100 hours elapsed, the luminance of the full green image is approximately 274.5 cd/m²

It can be seen from FIG. 17 that when N₂ is not added to the discharge gas, the luminance of the green image is sharply reduced as the acceleration time elapsed. Namely, the luminance is reduced as the acceleration time elapsed, and thus the image quality may worsen.

Further, when N₂ is not added to the discharge gas, a change amount of luminance depending on the acceleration time may be relatively large. More specifically, when N₂ is not added to the discharge gas, a maximum luminance is approximately 275 cd/m² and a minimum luminance is approximately 261 cd/m². A difference between the maximum and minimum luminances of the green image is approximately 14 cd/m². A large change amount of luminance may be a cause of a reduction in the uniformity of image quality.

On the other hand, when the N₂ content based on total weight of the discharge gas is 0.1%, 0.3%, and 1.0%, a change amount of luminance depending on the acceleration time may be relatively small.

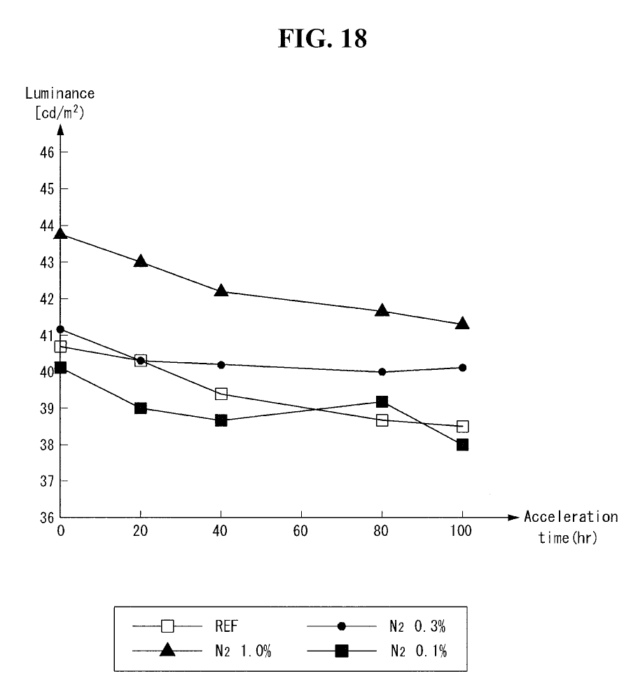

FIG. 18 is a graph showing a luminance of a full blue image depending on changes in a N₂ content.

As shown in FIG. 18, when the N₂ content is 0 (i.e., N₂ is not added to the discharge gas), a luminance of the full blue image before the panel is not accelerated is approximately 40.7 cd/m². After the acceleration time of about 20 hours elapsed, the luminance of the full blue image is approximately 40.3 cd/m². After the acceleration time of about 40 hours elapsed, the luminance of the full blue image is approximately 39.4 cd/m². After the acceleration time of about 80 hours elapsed, the luminance of the full blue image is approximately 38.7 cd/m². After the acceleration time of about 100 hours elapsed, the luminance of the full blue image is approximately 38.5 cd/m².

When the N₂ content based on total weight of the discharge gas is 0.1%, the luminance of the full blue image before the panel is not accelerated is approximately 40.1 cd/m². After the acceleration time of about 20 hours elapsed, the luminance of the full blue image is approximately 39 cd/m². After the acceleration time of about 40 hours elapsed, the luminance of the full blue image is approximately 38.7 cd/m². After the acceleration time of about 80 hours elapsed, the luminance of the full blue image is approximately 39.2 cd/m². After the acceleration time of about 100 hours elapsed, the luminance of the full blue image is approximately 38 cd/m².

When the N₂ content based on total weight of the discharge gas is 0.3%, the luminance of the full blue image before the panel is not accelerated is approximately 41.2 cd/m². After the acceleration time of about 20 hours elapsed, the luminance of the full blue image is approximately 40.3 cd/m². After the acceleration time of about 40 hours elapsed, the luminance of the full blue image is approximately 40.2 cd/m². After the acceleration time of about 80 hours elapsed, the luminance of the full blue image is approximately 40 cd/m². After the acceleration time of about 100 hours elapsed, the luminance of the full blue image is approximately 40.1 cd/m².

When the N₂ content based on total weight of the discharge gas is 1.0%, the luminance of the full blue image before the panel is not accelerated is approximately 43.8 cd/m². After the acceleration time of about 20 hours elapsed, the luminance of the full blue image is approximately 42.8 cd/m². After the acceleration time of about 40 hours elapsed, the luminance of the full blue image is approximately 42.2 cd/m². After the acceleration time of about 80 hours elapsed, the luminance of the full blue image is approximately 41.7 cd/m². After the acceleration time of about 100 hours elapsed, the luminance of the full blue image is approximately 41.3 cd/m².

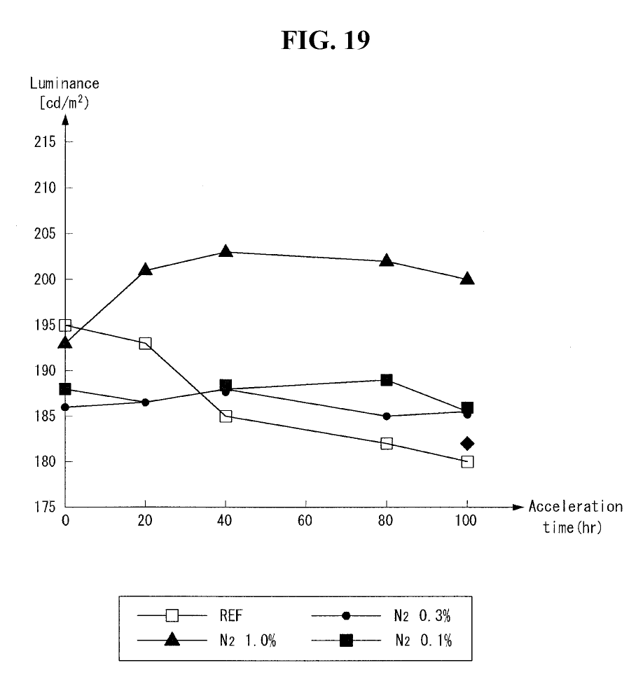

FIG. 19 is a graph showing a luminance of a full white image depending on changes in a N₂ content. The luminance of the full white image may be similar to a sum of the luminances of the full red, green, and blue images shown in FIGS. 16 to 18.

As shown in FIG. 19, when the N₂ content is 0 (i.e., N₂ is not added to the discharge gas), a luminance of the full white image before the panel is not accelerated is approximately 195 cd/m². After the acceleration time of about 20 hours elapsed, the luminance of the full white image is approximately 193 cd/m². After the acceleration time of about 40 hours elapsed, the luminance of the full white image is approximately 185 cd/m². After the acceleration time of about 80 hours elapsed, the luminance of the full white image is approximately 182 cd/m². After the acceleration time of about 100 hours elapsed, the luminance of the full white image is approximately 180 cd/m².

When the N₂ content based on total weight of the discharge gas is 0.1%, the luminance of the full white image before the panel is not accelerated is approximately 188 cd/m². After the acceleration time of about 20 hours elapsed, the luminance of the full white image is approximately 186.5 cd/m². After the acceleration time of about 40 hours elapsed, the luminance of the full white image is approximately 188 cd/m². After the acceleration time of about 80 hours elapsed, the luminance of the full white image is approximately 189 cd/m². After the acceleration time of about 100 hours elapsed, the luminance of the full white image is approximately 185 cd/m².

When the N₂ content based on total weight of the discharge gas is 0.3%, the luminance of the full white image before the panel is not accelerated is approximately 186 cd/m². After the acceleration time of about 20 hours elapsed, the luminance of the full white image is approximately 186.5 cd/m². After the acceleration time of about 40 hours elapsed, the luminance of the full white image is approximately 188 cd/m². After the acceleration time of about 80 hours elapsed, the luminance of the full white image is approximately 185 cd/m². After the acceleration time of about 100 hours elapsed, the luminance of the full white image is approximately 185.5 cd/m².

When the N₂ content based on total weight of the discharge gas is 1.0%, the luminance of the full white image before the panel is not accelerated is approximately 193 cd/m². After the acceleration time of about 20 hours elapsed, the luminance of the full white image is approximately 200.5 cd/m². After the acceleration time of about 40 hours elapsed, the luminance of the full white image is approximately 203 cd/m². After the acceleration time of about 80 hours elapsed, the luminance of the full white image is approximately 202.5 cd/m². After the acceleration time of about 100 hours elapsed, the luminance of the full white image is approximately 200 cd/m².

It can be seen from FIG. 19 that when N₂ is not added to the discharge gas, the luminance of the white image has a relatively large value in an initial period of acceleration but the luminance is sharply reduced as the acceleration time elapsed. Namely, the luminance is reduced as the acceleration time elapsed, and thus the image quality may worsen. Further, when N₂ is not added to the discharge gas, a maximum luminance of the white image is approximately 195 cd/m² and a minimum luminance is approximately 180 cd/m². A difference between the maximum and minimum luminances of the white image is approximately 15 cd/m². A large change amount of luminance may be a cause of a reduction in the uniformity of image quality.

On the other hand, when the N₂ content based on total weight of the discharge gas is 0.1%, 0.3%, and 1.0%, a change amount of luminance depending on the acceleration time may be relatively small. When the N₂ content based on total weight of the discharge gas is 1.0%, the relatively large luminance may be obtained irrespective of the acceleration time.

In the luminances of the red and blue images shown in FIGS. 16 and 18, the luminances when N₂ is not added to the discharge gas are larger than the luminances when the N₂ content based on total weight of the discharge gas is 0.1%. On the other hand, in the luminance of the green image shown in FIG. 17, the luminance when N₂ is not added to the discharge gas is sharply reduced as the acceleration time elapsed. As a result, the luminance characteristic of the white image when N₂ is not added to the discharge gas is not good.

Because a combined image of red, green, and blue images is actually displayed on the panel, the luminance of the white image may be more important than the luminances of the red, green, and blue images. Therefore, although luminance characteristics of the red and blue images are reduced, the luminance of the red or blue image may be negligible if the luminance characteristic of the white image is good.

As described above, when N₂ is not added to the discharge gas, the large change amount of luminance depending on the acceleration time is obtained, and the luminance may be excessively reduced as the acceleration time elapsed.

On the other hand, when the N₂ content based on total weight of the discharge gas is 0.1%, 0.3%, and 1.0%, the change amount of the white luminance depending on the acceleration time is not large, and the relatively large luminance is obtained. This is because N₂ generates ultraviolet (UV) rays having a long wavelength of 300 nm to 400 nm. Namely, N₂ can increase an amount of excitation particles inside the discharge cell and a kinetic energy of electrons, and thus the luminance can increase.

A experimental result similar to the experimental result shown in FIGS. 16 to 19 was obtained under the following experimental conditions:

1. A height of a barrier rib is approximately 110 μm to 125 μm.

2. A thickness of an upper dielectric layer is approximately 13 μm to 20 μm.

3. A thickness of a lower dielectric layer is approximately 10 μm to 13 μm.

4. A negative scan voltage −Vy is approximately −85 V to −75 V.

5. A sustain voltage Vs is approximately 190 V to 200 V.

6. A voltage magnitude of a scan reference signal Ybias is approximately 120 V to 140 V.

7. A voltage of a sustain reference signal Zbias is approximately 130V to 145V, and more specifically, the voltage of the sustain reference signal Zbias in an address period is approximately 130 V to 145 V.

Because the experimental result similar to the experimental result shown in FIGS. 16 to 19 was obtained under the above seven experimental conditions, it may be preferable that the panel is designed in conformity with the above seven experimental conditions when the scan electrode and the sustain electrode have the ITO-less electrode structure and N₂ is added to the discharge gas.

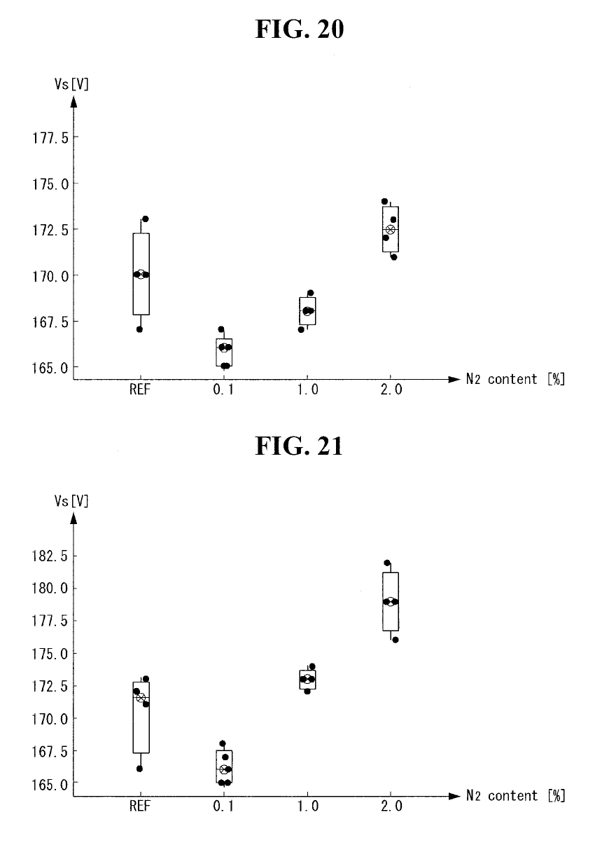

FIGS. 20 to 24 illustrate changes in a sustain voltage depending on changes in a N₂ content. More specifically, FIGS. 20 to 24 are graphs showing a minimum voltage Vsmin of a sustain signal SUS when the N₂ content in the discharge gas is 0.1%, 1.0%, and 2.0%. The minimum voltage Vsmin of the sustain signal SUS means a minimum voltage capable of generating a sustain discharge between the scan electrode and the sustain electrode during a sustain period.

In FIGS. 20 to 24, a dot (·) indicates a real measuring value of the minimum sustain voltage Vsmin, a rectangle indicates an error range of the minimum sustain voltage Vsmin in a longitudinal direction, and \textcircled{x} indicates an average value of the real measuring values. Hereinafter, the embodiment is described using the average value of the minimum sustain voltage Vsmin.

FIG. 20 illustrates a minimum sustain voltage Vsmin in a full red image.

As shown in FIG. 20, when N₂ is not added to the discharge gas, an average value of a minimum sustain voltage Vsmin is approximately 170 V. When the N₂ content based on total weight of the discharge gas is 0.1%, the average value of the minimum sustain voltage Vsmin is approximately 166 V. When the N₂ content based on total weight of the discharge gas is 1.0%, the average value of the minimum sustain voltage Vsmin is approximately 168.2 V. When the N₂ content based on total weight of the discharge gas is 2.0%, the average value of the minimum sustain voltage Vsmin is approximately 172.8 V.

The average value of the minimum sustain voltage Vsmin when the N₂ content based on total weight of the discharge gas is 0.1% and 1.0% is similar to or less than the average value of the minimum sustain voltage Vsmin when N₂ is not added to the discharge gas. However, the average value of the minimum sustain voltage Vsmin when the N₂ content based on total weight of the discharge gas is 2.0% is greater than the average value of the minimum sustain voltage Vsmin when N₂ is not added to the discharge gas.

FIG. 21 illustrates a minimum sustain voltage Vsmin in a full green image.

As shown in FIG. 21, when N₂ is not added to the discharge gas, an average value of a minimum sustain voltage Vsmin is approximately 171.5 V. When the N₂ content based on total weight of the discharge gas is 0.1%, the average value of the minimum sustain voltage Vsmin is approximately 166.2 V. When the N₂ content based on total weight of the discharge gas is 1.0%, the average value of the minimum sustain voltage Vsmin is approximately 173.2 V. When the N₂ content based on total weight of the discharge gas is 2.0%, the average value of the minimum sustain voltage Vsmin is approximately 179 V.

The average value of the minimum sustain voltage Vsmin when the N₂ content based on total weight of the discharge gas is 0.1% and 1.0% is similar to or less than the average value of the minimum sustain voltage Vsmin when N₂ is not added to the discharge gas. However, when the N₂ content based on total weight of the discharge gas is 2.0%, the average value of the minimum sustain voltage Vsmin sharply increase to approximately 180 V.

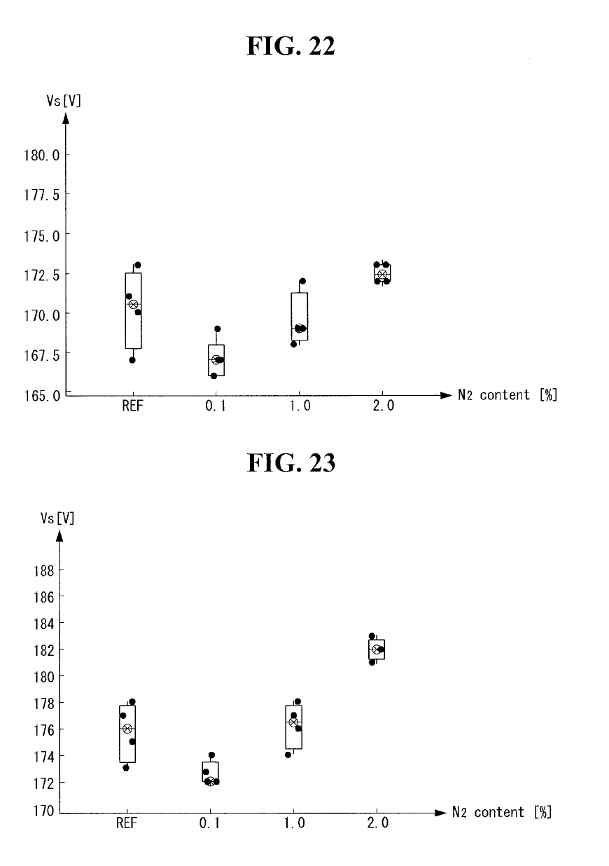

FIG. 22 illustrates a minimum sustain voltage Vsmin in a full blue image.

As shown in FIG. 22, when N₂ is not added to the discharge gas, an average value of a minimum sustain voltage Vsmin is approximately 170.6 V. When the N₂ content based on total weight of the discharge gas is 0.1%, the average value of the minimum sustain voltage Vsmin is approximately 167.1 V. When the N₂ content based on total weight of the discharge gas is 1.0%, the average value of the minimum sustain voltage Vsmin is approximately 169 V. When the N₂ content based on total weight of the discharge gas is 2.0%, the average value of the minimum sustain voltage Vsmin is approximately 172.5 V.

FIG. 23 illustrates a minimum sustain voltage Vsmin in a full white image.

As shown in FIG. 23, when N₂ is not added to the discharge gas, an average value of a minimum sustain voltage Vsmin is approximately 176 V. When the N₂ content based on total weight of the discharge gas is 0.1%, the average value of the minimum sustain voltage Vsmin is approximately 172.2 V. When the N₂ content based on total weight of the discharge gas is 1.0%, the average value of the minimum sustain voltage Vsmin is approximately 176.7 V. When the N₂ content based on total weight of the discharge gas is 2.0%, the average value of the minimum sustain voltage Vsmin is approximately 182.2 V.

The average value of the minimum sustain voltage Vsmin when the N₂ content based on total weight of the discharge gas is 0.1% and 1.0% is similar to or less than the average value of the minimum sustain voltage Vsmin when N₂ is not added to the discharge gas. However, when the N₂ content based on total weight of the discharge gas is 2.0%, the average value of the minimum sustain voltage Vsmin sharply increase to a value greater than 180 V.

In the embodiment, an increase in the average value of the minimum sustain voltage Vsmin means an increase in a driving voltage, and thus may mean a reduction in the driving efficiency.

FIG. 24 is a table showing the average value of the minimum sustain voltage Vsmin shown in FIGS. 20 to 23.

As shown in FIG. 24, in the full red image, when the N₂ content based on total weight of the discharge gas is 0.1%, the average value of the minimum sustain voltage Vsmin decreases to approximately 2.47%. When the N₂ content based on total weight of the discharge gas is 1.0%, the average value of the minimum sustain voltage Vsmin decreases to approximately 1.18%. On the other hand, when the N₂ content based on total weight of the discharge gas is 2.0%, the average value of the minimum sustain voltage Vsmin increases to approximately 2.83%.

In the full green image, when the N₂ content based on total weight of the discharge gas is 0.1%, the average value of the minimum sustain voltage Vsmin decreases to approximately 2.52%. When the N₂ content based on total weight of the discharge gas is 1.0%, the average value of the minimum sustain voltage Vsmin slightly increases to approximately 1.47%. On the other hand, when the N₂ content based on total weight of the discharge gas is 2.0%, the average value of the minimum sustain voltage Vsmin increases to approximately 6.07%.

In the full blue image, when the N₂ content based on total weight of the discharge gas is 0.1%, the average value of the minimum sustain voltage Vsmin decreases to approximately 1.91%. When the N₂ content based on total weight of the discharge gas is 1.0%, the average value of the minimum sustain voltage Vsmin slightly decreases to approximately 0.44%. On the other hand, when the N₂ content based on total weight of the discharge gas is 2.0%, the average value of the minimum sustain voltage Vsmin increases to approximately 2.53%.

In the full white image, when the N₂ content based on total weight of the discharge gas is 0.1%, the average value of the minimum sustain voltage Vsmin decreases to approximately 1.79%. When the N₂ content based on total weight of the discharge gas is 1.0%, the average value of the minimum sustain voltage Vsmin slightly increases to approximately 0.28%. On the other hand, when the N₂ content based on total weight of the discharge gas is 2.0%, the average value of the minimum sustain voltage Vsmin increases to approximately 4.15%.

Why the average value of the minimum sustain voltage Vsmin increases when the N₂ content based on total weight of the discharge gas excessively increases is that O₂ and N₂ in the panel are combined because of a large amount of N₂ to generate an NO gas. Namely, an amount of NO gas remaining in the panel may increase, and discharge characteristics of the panel may be reduced because of the NO gas as an impurity gas. Hence, the firing voltage between the scan electrode and the sustain electrode may increase.

Considering the above-described result, it may be preferable that the N₂ content based on total weight of the discharge gas is 0.1% to 1.0%.

The discharge gas may further contain at least two of neon (Ne), xenon (Xe), helium (He), and argon (Ar) gases in addition to N₂. For example, the discharge gas may include all of Ne, Ar, He, and Xe gases, and N₂.

When a discharge gas containing various kinds of gases is used, the efficiency may be improved because of a penning effect in which an ionization energy of the discharge gas is reduced due to a gas with a relatively low ionization energy.

A Xe content may increase so as to prevent a luminance reduction resulting from the ITO-less electrode structure. For example, the luminance reduction resulting from the ITO-less electrode structure may be suppressed by increasing a Xe content to approximately 20% based on total weight of the discharge gas.

However, if the Xe content in the discharge gas increases, a firing voltage may increase because of the properties of Xe gas. Namely, if the Xe content in the discharge gas increases so as to suppress the luminance reduction in the ITO-less electrode structure, the luminance reduction may be suppressed, but the driving efficiency may be reduced because of an increase in the firing voltage.

On the other hand, if N₂ is added to the discharge gas, the luminance reduction may be suppressed in the ITO-less electrode structure, and also an excessive increase in the firing voltage may be suppressed.

Accordingly, the luminance reduction and an increase in the firing voltage may be suppressed by adding N₂ to the discharge gas in a state where a proper amount of Xe (15% of Xe based on total weight of the discharge gas) is added to the discharge gas in the ITO-less electrode structure.

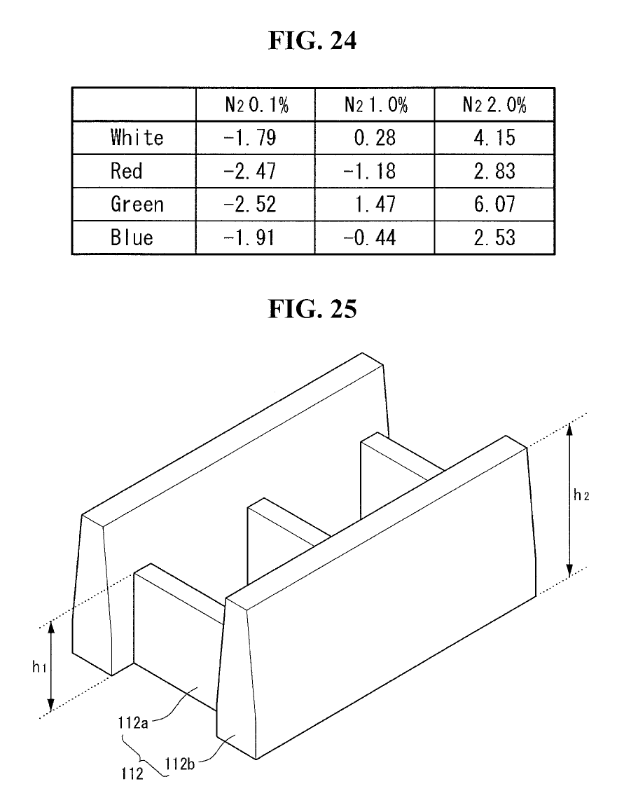

FIGS. 25 to 28 illustrate a barrier rib and a phosphor layer on the barrier rib.

As shown in FIG. 25, the barrier rib 112 may include first and second barrier ribs 112a and 112b crossing each other. Heights of the first and second barrier ribs 112a and 112b may be different from each other. For example, a height h1 of the first barrier rib 112a may be smaller than a height h2 of the second barrier rib 112b. In this case, in an exhaust process and a process for injecting a discharge gas, an impurity gas in the panel 100 may be efficiently exhausted to the outside of the panel 100, and the discharge gas may be evenly diffused inside the panel 100.

The first barrier rib 112a may be substantially parallel to the first electrode, and the second barrier rib 112b may be substantially parallel to the second electrode. When a direction parallel to longer sides of the front and rear substrates is referred to as a transverse direction and a direction parallel to shorter sides of the front and rear substrates is referred to as a longitudinal direction, the first barrier rib 112a may be a transverse barrier rib formed in the transverse direction and the second barrier rib 112b may be a longitudinal barrier rib formed in the longitudinal direction.

The first barrier rib 112a may partition two adjacent discharge cells generating light of the same color among the discharge cells, and thus phosphor layers of the same color may be respectively formed inside the two adjacent discharge cells. The second barrier rib 112b may partition two adjacent discharge cells generating light of different colors among the discharge cells, and thus phosphor layers of different colors may be respectively formed inside the two adjacent discharge cells.

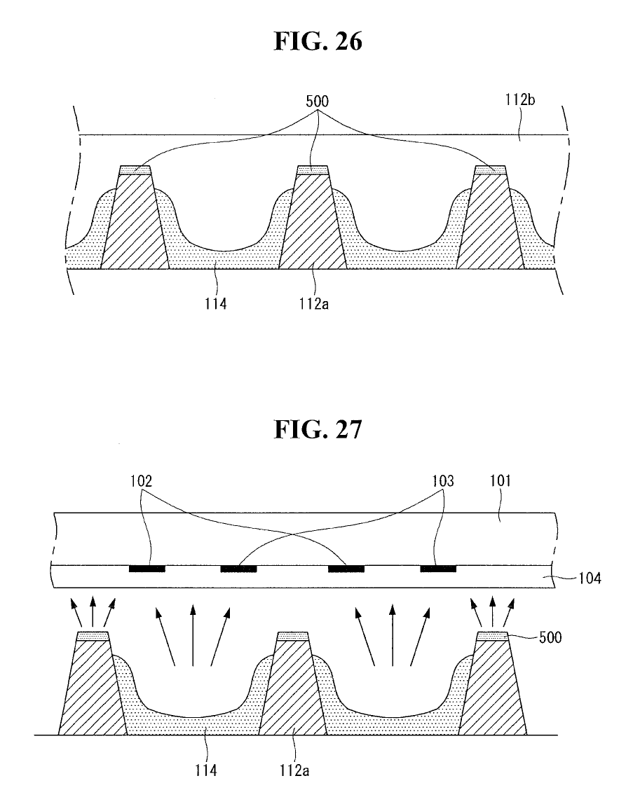

As shown in FIG. 26, another phosphor layer 500 may be formed on the first barrier rib 112a.

In the embodiment, the phosphor layer 500 on the first barrier rib 112a is referred to as a second phosphor layer 500, and the phosphor layer 114 inside the discharge cell is referred to as a first phosphor layer 114.

FIG. 26 shows that the second phosphor layer 500 is positioned on the first barrier rib 112a in a state where the height of the first barrier rib 112a is smaller than the height of the second barrier rib 112b. However, the second phosphor layer 500 may be positioned on the first barrier rib 112a in a state where the height of the first barrier rib 112a is substantially equal to the height of the second barrier rib 112b.

As described above, when the second phosphor layer 500 is formed on the first barrier rib 112a, as shown in FIG. 27, light may be generated in the second phosphor layer 500 on the first barrier rib 112a as well as the first phosphor layer 114 inside the discharge cell during a discharge operation. Hence, a luminance may be improved.

When a discharge occurs between the scan electrode 102 and the sustain electrode 103, the generated discharge is diffused toward the rear substrate 111. However, the diffused discharge may be a cause of deterioration of the second phosphor layer 500.

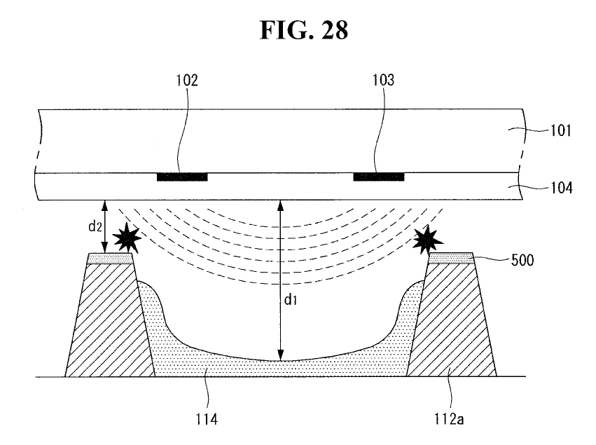

More specifically, as shown in FIG. 28, because the upper dielectric layer 104 is separated from the first phosphor layer 114 with a sufficiently long distance d1, the first phosphor layer 114 is not easily deteriorated by a discharge occurring between the scan electrode 102 and the sustain electrode 103. However, because a distance d2 between the upper dielectric layer 104 and the second phosphor layer 500 is short, the second phosphor layer 500 may be easily deteriorated by a discharge occurring between the scan electrode 102 and the sustain electrode 103.

If the second phosphor layer 500 is deteriorated, light emitting characteristics of the second phosphor layer 500 may worsen. Hence, the image quality and a luminance may be reduced.

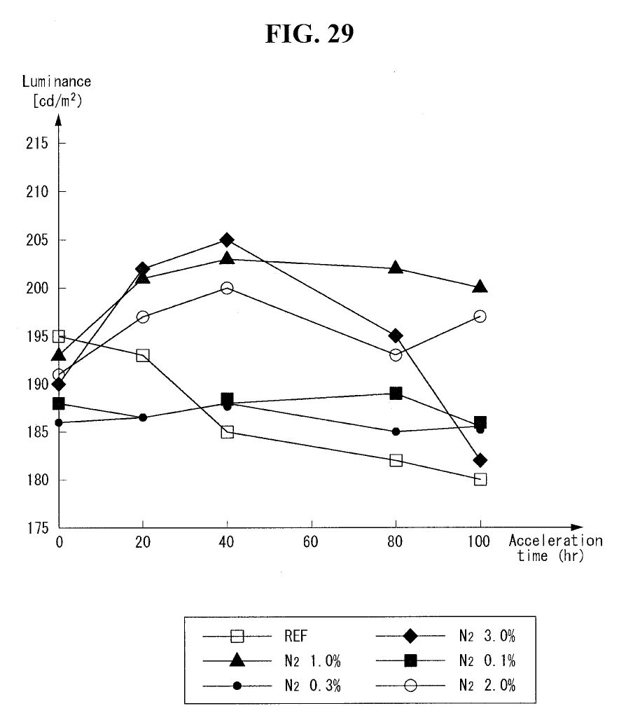

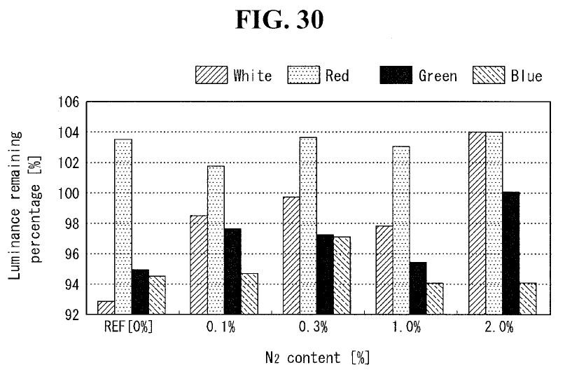

FIGS. 29 and 30 illustrate a luminance and a luminance remaining percentage of red, green, blue, and white images depending on changes in a content of N₂ added to a discharge gas.

Experimental conditions for measurement of a luminance are as follows:

1. The discharge gas includes 15% of xenon (Xe) based on total weight of the discharge gas.

2. A pressure of the discharge gas is 370 torr.

3. The N₂ content in the discharge gas changes to 0%, 0.1%, 0.3%. 1.0%, 2.0%, or 3.0% under the above two conditions.

A method for measuring the luminance is as follows:

While full red, full green, full blue, and full white images are displayed on a panel of a finished state fabricated in a production line for 0 to 120 hours, a luminance of each image is measured. A display time of each image on the panel is referred to as an acceleration time.

The luminance remaining percentage is a percentage of a luminance of the finished panel after the finished panel is accelerated for 100 hours based on a luminance of the finished panel in an initial period of acceleration. The high luminance remaining percentage means that a reduction of the luminance is sufficiently suppressed. Namely, the high luminance remaining percentage means that the phosphor is slowly deteriorated.

FIG. 29 is a graph showing a luminance of a full white image depending on changes in a N₂ content.

As shown in FIG. 29, when the N₂ content is 0 (i.e., N₂ is not added to the discharge gas), a luminance of the full white image before the panel is not accelerated is approximately 195 cd/m². After the acceleration time of about 20 hours elapsed, the luminance of the full white image is approximately 193 cd/m². After the acceleration time of about 40 hours elapsed, the luminance of the full white image is approximately 185 cd/m². After the acceleration time of about 80 hours elapsed, a luminance of the full white image is approximately 182 cd/m². After the acceleration time of about 100 hours elapsed, the luminance of the full white image is approximately 180 cd/m².

Next, when the N₂ content based on total weight of the discharge gas is 0.1%, the luminance of the full white image before the panel is not accelerated is approximately 188 cd/m². After the acceleration time of about 20 hours elapsed, the luminance of the full white image is approximately 186.5 cd/m². After the acceleration time of about 40 hours elapsed, the luminance of the full white image is approximately 188 cd/m². After the acceleration time of about 80 hours elapsed, the luminance of the full white image is approximately 189 cd/m². After the acceleration time of about 100 hours elapsed, the luminance of the full white image is approximately 185 cd/m².

Next, when the N₂ content based on total weight of the discharge gas is 0.3%, the luminance of the full white image before the panel is not accelerated is approximately 186 cd/m². After the acceleration time of about 20 hours elapsed, the luminance of the full white image is approximately 186.5 cd/m². After the acceleration time of about 40 hours elapsed, the luminance of the full white image is approximately 188 cd/m². After the acceleration time of about 80 hours elapsed, the luminance of the full white image is approximately 185 cd/m². After the acceleration time of about 100 hours elapsed, the luminance of the full white image is approximately 185.5 cd/m².

Next, when the N₂ content based on total weight of the discharge gas is 1.0%, the luminance of the full white image before the panel is not accelerated is approximately 193 cd/m². After the acceleration time of about 20 hours elapsed, the luminance of the full white image is approximately 200.5 cd/m². After the acceleration time of about 40 hours elapsed, the luminance of the full white image is approximately 203 cd/m². After the acceleration time of about 80 hours elapsed, the luminance of the full white image is approximately 202.5 cd/m². After the acceleration time of about 100 hours elapsed, the luminance of the full white image is approximately 200 cd/m².

Next, when the N₂ content based on total weight of the discharge gas is 2.0%, the luminance of the full white image before the panel is not accelerated is approximately 191 cd/m². After the acceleration time of about 20 hours elapsed, the luminance of the full white image is approximately 197 cd/m². After the acceleration time of about 40 hours elapsed, the luminance of the full white image is approximately 200 cd/m². After the acceleration time of about 80 hours elapsed, the luminance of the full white image is approximately 193 cd/m². After the acceleration time of about 100 hours elapsed, the luminance of the full white image is approximately 197 cd/m².

Next, when the N₂ content based on total weight of the discharge gas is 3.0%, the luminance of the full white image before the panel is not accelerated is approximately 190 cd/m². After the acceleration time of about 20 hours elapsed, the luminance of the full white image is approximately 202 cd/m². After the acceleration time of about 40 hours elapsed, the luminance of the full white image is approximately 205 cd/m². After the acceleration time of about 80 hours elapsed, the luminance of the full white image is approximately 195 cd/m². After the acceleration time of about 100 hours elapsed, the luminance of the full white image is approximately 182 cd/m².

When the N₂ content based on total weight of the discharge gas is 3.0%, a maximum luminance of the full white image has a relatively great value of approximately 205 cd/m². However, a change width of the luminance depending on acceleration time is great. More specifically, the maximum luminance of the full white image is approximately 205 cd/m², and a minimum luminance of the full white image is 182 cd/m². A difference between the maximum and minimum luminances is approximately 23 cd/m².

If the change width of the luminance depending on the acceleration time is great, a change width of a luminance of an image may increase. Hence, uniformity of the image quality is reduced.

When N₂ is not added to the discharge gas, the luminance of the full white image has a relatively great value in an initial time of acceleration. However, as the acceleration time elapsed, the luminance of the full white image is sharply reduced. Hence, the image quality may worsen. Furthermore, a maximum luminance of the full white image is approximately 195 cd/m², and a minimum luminance of the full white image is 180 cd/m². A difference between the maximum and minimum luminances is approximately 15 cd/m². Hence, uniformity of the image quality is reduced.

On the other hand, when the N₂ content based on total weight of the discharge gas is 0.1%, 0.3%, 1.0%, and 2.0%, a change width of the luminance depending on the acceleration time is narrow. When the N₂ content based on total weight of the discharge gas is 1.0%, the luminance of the full white image has a relatively great value irrespective of the acceleration time. This is because N₂ generates ultraviolet (UV) rays having a long wavelength of 300 nm to 400 nm. Namely, N₂ can increase an amount of excitation particles inside the discharge cell and a kinetic energy of electrons, and thus the luminance can increase.

FIG. 30 is a graph showing a luminance remaining percentage of red, green, blue, and white images depending on changes in the N₂ content.

As shown in FIG. 30, when N₂ is not added to the discharge gas, a luminance remaining percentage of red light is a relatively great value of approximately 103%. A luminance remaining percentage of green light is approximately 95%, a luminance remaining percentage of blue light is slightly greater than approximately 95%, and a luminance remaining percentage of white light is smaller than approximately 93%. A reason why the luminance remaining percentage is reduced is that an amount of light capable of being generated by the phosphor is reduced as the panel is accelerated.

In particular, when the phosphor layer is formed on the transverse barrier rib so as to increase the luminance, the luminance remaining percentage of white light is smaller than 93% because the deterioration of the phosphor layer on the transverse barrier rib deepens as the panel is accelerated.

When the N₂ content based on total weight of the discharge gas is 0.1%, a luminance remaining percentage of red light is slightly smaller than approximately 102%, a luminance remaining percentage of green light is slightly greater than approximately 98.5%, and a luminance remaining percentage of blue light is slightly smaller than approximately 95%. Further, a luminance remaining percentage of white light is a relatively great value of approximately 98.5%.

When the N₂ content based on total weight of the discharge gas is 0.3%, a luminance remaining percentage of red light is slightly smaller than approximately 103.5%, a luminance remaining percentage of green light is slightly greater than approximately 97%, and a luminance remaining percentage of blue light is approximately 97%. Further, a luminance remaining percentage of white light is a relatively great value slightly smaller than approximately 100%.

When the N₂ content based on total weight of the discharge gas is 1.0%, a luminance remaining percentage of red light is approximately 103%, a luminance remaining percentage of green light is approximately 95.5%, and a luminance remaining percentage of blue light is approximately 94%. Further, a luminance remaining percentage of white light is a relatively great value slightly smaller than approximately 98%.

When the N₂ content based on total weight of the discharge gas is 2.0%, a luminance remaining percentage of red light is approximately 104%, a luminance remaining percentage of green light is approximately 100% and a luminance remaining percentage of blue light is approximately 94%. Further, a luminance remaining percentage of white light is a relatively great value of approximately 104%.

It can be seen from FIG. 30 that the luminance remaining percentage when the N₂ content based on total weight of the discharge gas is 0.1%, 0.3%, 1.0%, and 2.0% is greater than the luminance remaining percentage when N₂ is not added to the discharge gas. Namely, because N₂ suppresses the deterioration of the phosphor layer, after the acceleration time of 100 hours elapsed, a reduction in an amount of light generated by the phosphor layer is prevented.

A reason why the use of a N₂ containing discharge gas reduces the deterioration of the phosphor will be described below.

N₂ emits ultraviolet (UV) rays with a relatively long wavelength during a discharge. For example, in case a 2-element gas obtained by mixing neon (Ne) with xenon (Xe) is used as a discharge gas, UV rays with a relatively short wavelength equal to or less than approximately 200 nm are generated during a discharge. When the relatively short wavelength UV rays excite a phosphor, the phosphor may be easily deteriorated because of a high energy of the vacuum UV rays. On the other hand, if N₂ is added to the 2-element discharge gas, a wavelength of UV rays generated during a discharge increases to a value equal to or greater than 230 nm because of the properties of N₂. Namely, the long wavelength UV rays are generated during a discharge. Because the long wavelength UV rays have a relatively low energy, the deterioration of the phosphor may be reduced when the phosphor is excited by the long wavelength UV rays.

Considering the description of FIGS. 29 and 30, when the phosphor layer is formed on the transverse barrier rib so as to increase the luminance, it may be preferable that a N₂ containing discharge gas is used to prevent the deterioration of the phosphor layer on the transverse barrier rib.

An excessively large amount of N₂ may increase a change amount of luminance depending on the acceleration time, and thus the uniformity of the image quality may be reduced. Therefore, it may be preferable that a N₂ content based on total weight of the discharge gas is 0.1 to 2.0%.

The discharge gas may further contain at least two of Ne, Ar, and Xe gases in addition to N₂. For example, the discharge gas may include all of Ne, Ar, and Xe gases, and N₂.

When a discharge gas containing various kinds of gases is used, the efficiency may be improved because of a penning effect in which an ionization energy of the discharge gas is reduced due to a gas with a relatively low ionization energy.

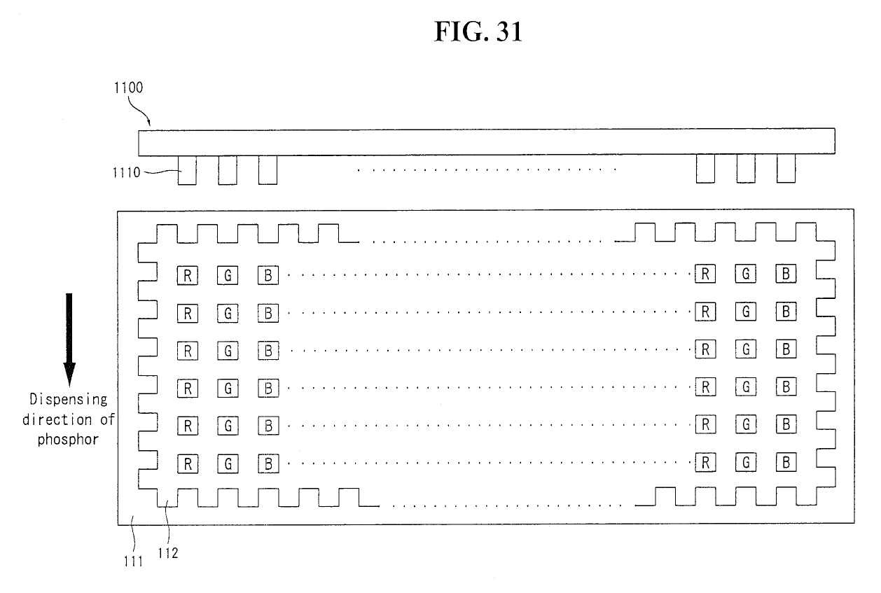

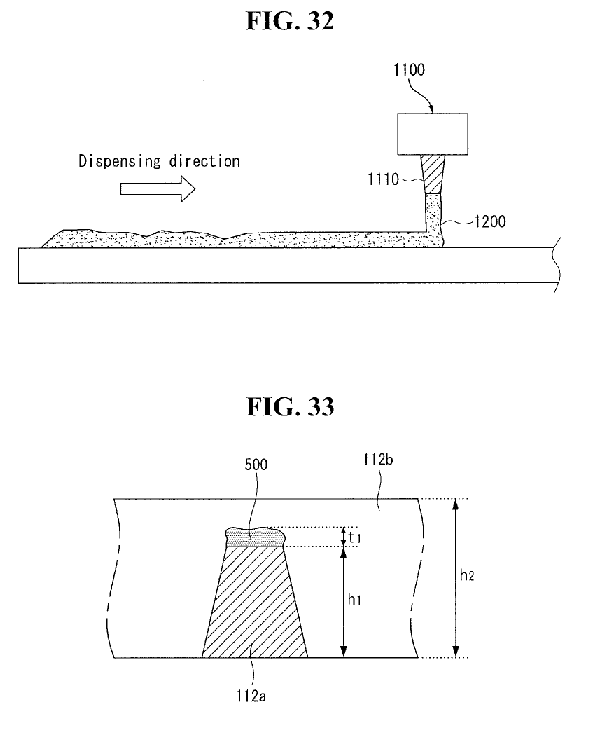

FIGS. 31 and 32 illustrate an exemplary method of forming a phosphor layer.

As shown in FIG. 31, a phosphor layer may be formed using a dispensing method. For example, a dispensing device 1100 may dispense a phosphor material of a paste or a slurry state inside the discharge cell partitioned by the barrier rib 112 on the substrate 111 through a nozzle 1110. Then, a drying or firing process may be performed on the phosphor material to form a phosphor layer.

As shown in FIG. 31, a dispensing direction of the phosphor material may be substantially parallel to a direction of a longitudinal barrier rib of the barrier rib 112 formed in a direction crossing a longer side of the substrate 111.

As shown in FIG. 32 being a side view, the dispensing device 1100 may dispense a phosphor material 1200 through the nozzle 1110 in an arrow direction.

In a dispensing process, if the dispensing device 1100 continuously dispenses the phosphor material 1200 while the nozzle 1110 passes through an upper portion of a transverse barrier rib (i.e., a first barrier rib) of the barrier rib 112, a phosphor layer may be formed on the upper portion of the first barrier rib. Further, the phosphor material 1200 may be easily dispensed on the upper portion of the first barrier rib by adjusting a viscosity of the phosphor material 1200.

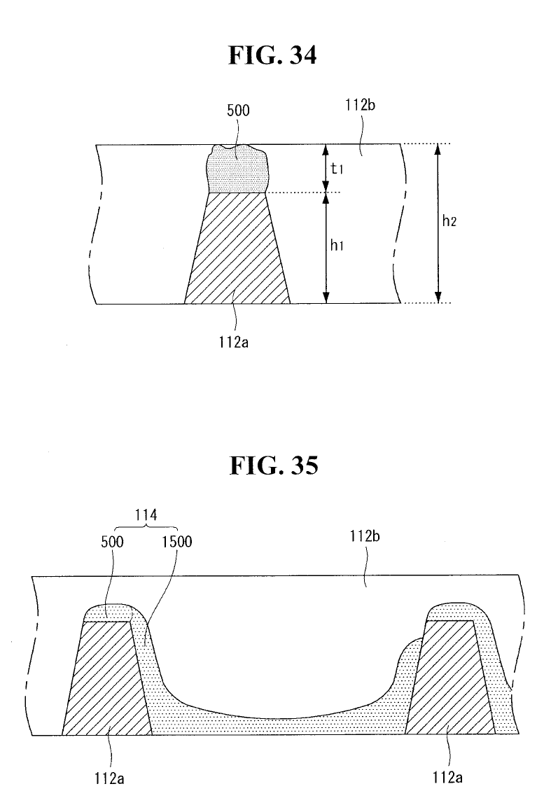

FIGS. 33 and 34 are diagrams for explaining heights of a barrier rib and a phosphor layer.

When a height h1 of the first barrier rib 112a included in the barrier rib 112 is smaller than a height h2 of the second barrier rib 112b included in the barrier rib 112, a height t1 of the second phosphor layer 500 on the first barrier rib 112a may be determined so that light generated by the second phosphor layer 500 is more efficiently emitted to the outside and a distance between the front and rear substrates is properly maintained.

For example, as shown in FIG. 33, a sum of the height h1 of the first barrier rib 112a and the height t1 of the second phosphor layer 500 may be smaller than the height h2 of the second barrier rib 112b. In this case, because a sufficient space between the second phosphor layer 500 and the front substrate is secured, light generated by the second phosphor layer 500 can be efficiently emitted to the outside. Hence, a luminance may increase more efficiently.

Alternatively, as shown in FIG. 34, a sum of the height h1 of the first barrier rib 112a and the height t1 of the second phosphor layer 500 may be substantially equal to the height h2 of the second barrier rib 112b. In this case, light generated by the second phosphor layer 500 can be efficiently emitted to the outside. Hence, a luminance may increase more efficiently.

Although it is not shown, it is possible to form the second phosphor layer 500 on the first barrier rib 112a in a state where the height h1 of the first barrier rib 112a is substantially equal to the height h2 of the second barrier rib 112b under condition that light generated by the second phosphor layer 500 is efficiently emitted to the outside and a distance between the front and rear substrates is properly maintained.

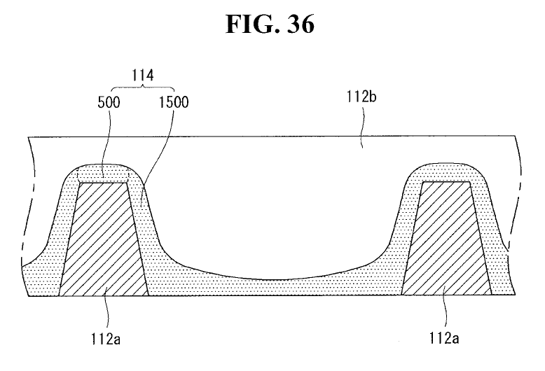

FIGS. 35 and 36 illustrate another structure of a phosphor layer.

In FIGS. 35 and 36, the phosphor layer 500 on the first barrier rib 112a is referred to as a second phosphor layer, and a phosphor layer 1500 inside the discharge cell is referred to as a first phosphor layer. The first phosphor layer 1500 may be connected to the second phosphor layer 500.

For example, as shown in FIG. 35, the second phosphor layer 500 between two adjacent discharge cells emitting light of the same color may be connected to the first phosphor layer 1500 formed in one discharge cell of the two adjacent discharge cells. The above structure may be formed depending on a dispensing direction of the phosphor material.

Alternatively, as shown in FIG. 36, the second phosphor layer 500 between two adjacent discharge cells emitting light of the same color may be connected to the first phosphor layers 1500 formed in the two adjacent discharge cells (i.e., the first phosphor layers 1500 formed at both sides of the second phosphor layer 500). Hence, the first phosphor layers 1500 in the two adjacent discharge cells with the first barrier rib 112a interposed between the two adjacent discharge cells may be connected to each other.

As described above, when the first phosphor layer 1500 and the second phosphor layer 500 are connected to each other, an entire surface area of the phosphor layer 114 may increase. Hence, the luminance may further increase.

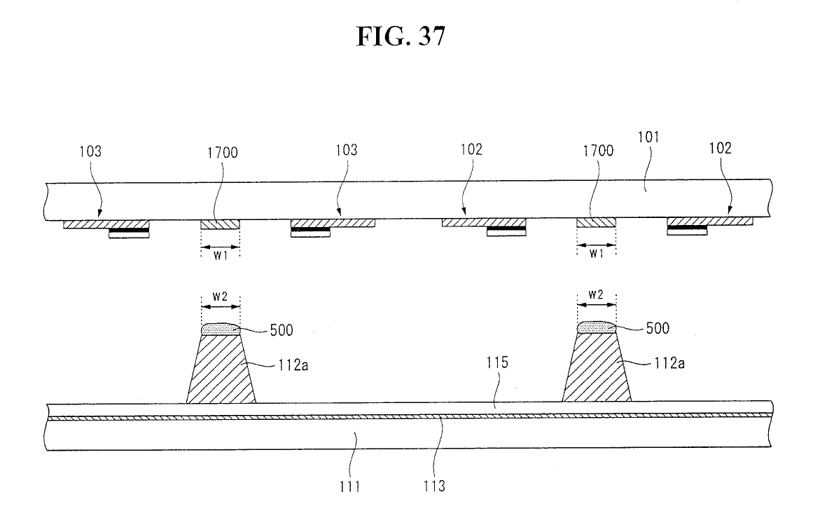

FIGS. 37 to 39 illustrate a black layer.

As shown in FIG. 37, a black layer 1700 may be formed at a location corresponding to the first barrier rib 112a on the front substrate.

The black layer 1700 may be different from a black layer included in each of the scan electrode 102 and the sustain electrode 103. In FIGS. 37 to 39, the black layer included in each of the scan electrode 102 and the sustain electrode 103 is referred to as a first black layer, and the black layer 1700 is referred to as a second black layer.

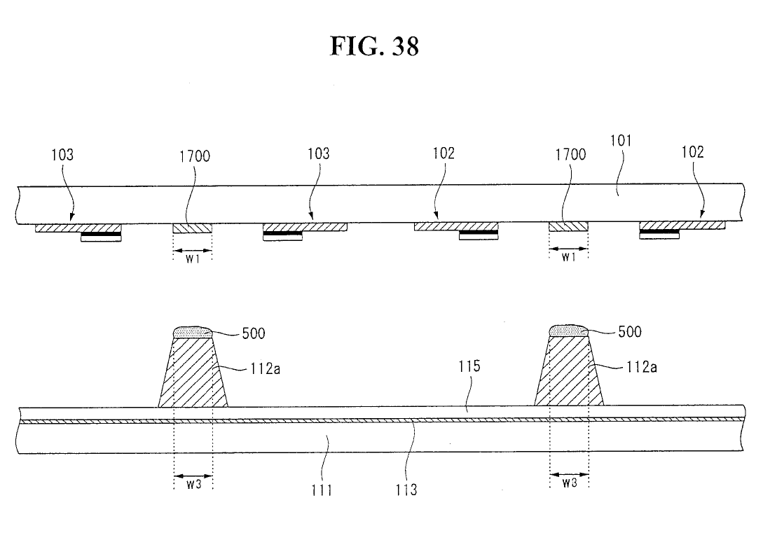

As shown in FIG. 37, a width W1 of the black layer 1700 may be equal to or smaller than a width W2 of the second phosphor layer 500 on the first barrier rib 112a. Alternatively, as shown in FIG. 38, the width W1 of the black layer 1700 may be equal to or smaller than a width W3 of the first barrier rib 112a. The width W3 of the first barrier rib 112a may be an upper width of the first barrier rib 112a.

As described above, when the width W1 of the black layer 1700 is equal to or smaller than the width W2 of the second phosphor layer 500 or the width W3 of the first barrier rib 112a, light generated by the second phosphor layer 500 may be sufficiently emitted to the outside. When the width W1 of the black layer 1700 is greater than the width W2 of the second phosphor layer 500 or the width W3 of the first barrier rib 112a, light generated by the second phosphor layer 500 may be blocked by the black layer 1700. Hence, it is difficult to sufficiently emit the light to the outside.

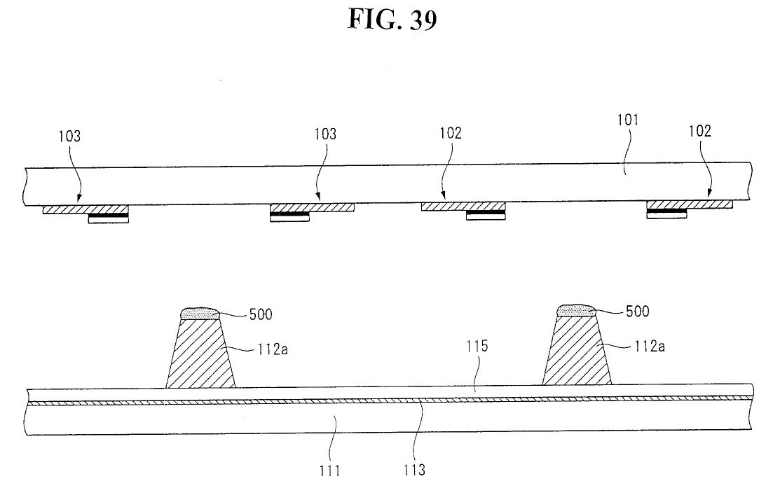

As shown in FIG. 39, the black layer 1700 may be omitted. In this case, light coming from the outside may be reflected by the second phosphor layer 500. However, because light generated by the second phosphor layer 500 can be maximumly emitted to the outside, contrast characteristics may be improved.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A plasma display panel comprising:
a front substrate on which a scan electrode and a sustain electrode are positioned substantially parallel to each other, the scan electrode and the sustain electrode being ITO-less electrodes;
a rear substrate on which an address electrode is positioned to cross the scan electrode and the sustain electrode; and
a discharge gas filled in a space between the front substrate and the rear substrate, the discharge gas containing a nitrogen gas (N₂).

2. A plasma display panel of claim 1, wherein a N₂ content is 0.1% to 1.0% based on total weight of the discharge gas.

3. A plasma display panel of claim 1, wherein the discharge gas further includes at least two of neon (Ne), xenon (Xe), helium (He), and argon (Ar) gases.

4. A plasma display panel of claim 1, wherein the scan electrode and the sustain electrode each include:
at least one line portion that crosses the address electrode; and
at least one projection portion that projects from the line portion in a direction substantially parallel to a formation direction of the address electrode.

5. A plasma display panel of claim 4, wherein the projection portion includes at least one first projection portion projecting in a first direction and at least one second projection portion projecting in a second direction opposite the first direction.

6. A plasma display panel of claim 5, wherein a length of the first projection portion is different from a length of the second projection portion, or a width of the first projection portion is different from a width of the second projection portion.

7. A plasma display panel of claim 4, wherein the line portion is plural,
wherein each of the scan electrode and the sustain electrode further includes a connection portion connecting at leas two line portions of the plurality of line portions to each other.

8. A plasma display panel of claim 7, wherein a number of connection portions included in each of the scan electrode and the sustain electrode is one,
wherein a number of projection portions included in each of the scan electrode and the sustain electrode is one.

9. A plasma display panel of claim 8, wherein the projection portion and the connection portion are arranged in a straight line.

10. A plasma display panel of claim 1, further comprising a barrier rib between the front substrate and the rear substrate, a height of the barrier rib being approximately 110 μm to 125 μm.

11. A plasma display panel of claim 1, further comprising an upper dielectric layer on the front substrate, a thickness of the upper dielectric layer being approximately 13 μm to 20 μm.

12. A plasma display panel of claim 1, further comprising a lower dielectric layer on the rear substrate, a thickness of the lower dielectric layer being approximately 10 μm to 13 μm.

13. A plasma display apparatus comprising:
a plasma display panel including a front substrate on which a scan electrode and a sustain electrode are positioned substantially parallel to each other, a rear substrate opposite the front substrate, and a discharge gas filled in a space between the front substrate and the rear substrate; and
a driver that supplies a negative scan voltage, a sustain voltage, a scan reference signal, and a sustain reference signal to the scan electrode,
wherein the scan electrode and the sustain electrode are ITO-less electrodes,
wherein the discharge gas contains a nitrogen gas (N₂).

14. A plasma display apparatus of claim 13, wherein the negative scan voltage is approximately −85 V to −75 V.

15. A plasma display apparatus of claim 13, wherein the sustain voltage is approximately 190 V to 200 V.

16. A plasma display apparatus of claim 13, wherein a voltage magnitude of the scan reference signal is approximately 120 V to 140 V.

17. A plasma display apparatus of claim 13, wherein a voltage of the sustain reference signal is approximately 130 V to 145 V.

18. A plasma display apparatus of claim 13, wherein a N₂ content is 0.1% to 1.0% based on total weight of the discharge gas.

19. A plasma display apparatus of claim 13, wherein the discharge gas further includes at least two of neon (Ne), xenon (Xe), helium (He), and argon (Ar) gases.

20. A plasma display apparatus of claim 13, wherein the scan electrode and the sustain electrode each include:
at least one line portion that crosses an address electrode; and
at least one projection portion that projects from the line portion in a direction substantially parallel to a formation direction of the address electrode.
